(19) United States
(12) Patent Application Publication
(10) Pub. No.: US 2026/0193483 A1
(43) Pub. Date: Jul. 9, 2026

(54) INKJET INKS CONTAINING AMINE MODIFIED SILICONE

(71) Applicant: KAO CORPORATION, Tokyo (JP)

(72) Inventors: Daniel SANDKER, Cincinnati, OH (US); Yuta MATSUMOTO, Cincinnati, OH (US)

(73) Assignee: KAO CORPORATION, Tokyo (JP)

(21) Appl. No.: 19/133,868

(22) PCT Filed: Nov. 28, 2023
(86) PCT No.: PCT/US2023/081367

§ 371 Date: May 29, 2025

(30) Foreign Application Priority Data
Nov. 30, 2022 (WO) PCT/US2022/051379

(51) Int. Cl. C09D 11/38; B41M 5/00; B41M 7/00; C09D 11/033; C09D 11/037; C09D 11/102; C09D 11/103; C09D 11/328

(52) U.S. Cl. CPC C09D 11/38; B41M 5/0088; B41M 7/009; C09D 11/033; C09D 11/037; C09D 11/102; C09D 11/103; C09D 11/328

(57) ABSTRACT

An inkjet ink that includes (A) a terpene phenol resin, (B) a solvent system containing (B1) ethanol and (B2) a cosolvent, and (C) an amine modified silicone that includes a silicone backbone (main chain) and one or more organoamine side chains attached to the silicone backbone, the inkjet ink being characterized by extended decap times and superior adhesion to a variety of substrates, A printed article including the inkjet ink in dried form, and a method of forming a printed image with a thermal inkjet printhead are also provided.

### CROSS-REFERENCE TO RELATED APPLICATIONS

The present application claims priority to PCT Application No. PCT/US2022/051379, filed Nov. 30, 2022.

### BACKGROUND OF THE INVENTION

### Field of the Invention

The present invention relates to solvent-based inkjet inks, specifically inkjet inks formulated with (A) a terpene phenol resin, (B) a solvent system comprising (B1) ethanol and (B2) a cosolvent, and (C) an amine modified silicone that includes a silicone backbone (main chain) and one or more organoamine side chains attached to the silicone backbone.

### Discussion of the Background

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Thermal inkjet (TIJ) printing is a desirable technology for printing, coding, and marking as it offers high print resolutions at lower costs than competing technologies in the field, such as continuous inkjet (CIJ) methods. In thermal inkjet printing processes, the print cartridges contain a series of tiny chambers, each containing a heater, which produce ink droplets from thermal vaporization of an ink solvent. In the jetting process, a resistor is heated rapidly to produce a vapor bubble (hence the phrase “bubble jet”), which subsequently ejects a droplet from the orifice. This process is extremely efficient and reproducible and modern TIJ printheads for industrial graphics applications are capable of generating uniform droplets of 4 μL or smaller in volume at frequencies of 36 kHz or greater.

However, industrial marking and coding regularly requires the printing of essential information—such as personal information, labels, codes, dating (e.g., expirations dates), and traceability information (e.g., manufacturing lot)—onto substrates having a complex surface, for example, substrates which are radial, curved, serrated, corrugated, fluted, and/or lipped or a variety of different substrates, for example porous and non-porous substrates or substrates formed from materials having different physiochemical properties. These different substrate properties can result in different ink adhesion properties. If the ink cannot properly adhere to the substrate, the resulting printed image will be of poor image quality. Poor image quality is unacceptable for many applications, but particularly so for marking and coding of essential information. Addition of resin to the ink has been proposed as a means of improving adhesion.

However, thermal inkjet printing can be troubled by poor reliability after periods of inactivity in resin-added systems. For example, some inkjet inks suffer from short decap times, in which solvent losses due to prolonged exposure to air within an uncapped printhead leads to clogging/plugging of printhead nozzles, and thus unreliable ink jetting and image quality erosion over time.

Solvent-based inkjet inks have been made using specific combinations of binder resins, modified silicones and volatile organic solvents or solvent mixtures which include ethanol, and colorants. For example, WO2021176086 discloses an inkjet ink comprising a polyether modified silicone and ethanol. However, this reference does not contain an amine modified silicone.

### SUMMARY OF THE INVENTION

In view of the forgoing, there is a need for inkjet inks that have extended decap times and adhere strongly to multiple substrates.

Accordingly, it is one object of the present invention to provide novel inkjet inks that meet these criteria.

It is another object of the present disclosure to provide novel printed articles which contain a dried form of the inkjet inks.

It is another object of the present disclosure to provide novel methods of forming a printed image on a substrate by applying the inkjet inks onto the substrate and drying.

These and other objects, which will become apparent during the following detailed description, have been achieved by the inventors' discovery that the combination of a terpene phenol resin, a solvent system comprising ethanol and a cosolvent, and an amine modified silicone provides inkjet inks characterized by extended decap times and superior adhesion to substrates.

Thus, the present invention provides:
(1) An inkjet ink, comprising:
(A) a terpene phenol resin;
(B) a solvent system comprising (B1) ethanol and (B2) a cosolvent; and
(C) an amine modified silicone,
wherein the amine modified silicone (C) comprises a silicone backbone (main chain) and one or more organoamine side chains attached to the silicone backbone.
(2) The inkjet ink of (1), wherein the terpene phenol resin (A) is a copolymer comprising a monoterpene segment and a phenolic segment comprising a phenolic compound, wherein the phenolic segment is connected to the monoterpene segment in at least one selected from the group consisting of an ortho-position relative to a phenolic hydroxyl group and a para-position relative to the phenolic hydroxyl group.
(3) The inkjet ink of (2), wherein:
the monoterpene segment is at least one bicyclic monoterpene selected from the group consisting of 3-carene, α-pinene, β-pinene, and camphene; and
the phenolic compound is phenol.
(4) The inkjet ink of any one of (1) to (3), wherein the terpene phenol resin (A) has a hydroxyl value of 10 to 75 mgKOH/g.
(5) The inkjet ink of any one of (1) to (4), wherein the terpene phenol resin (A) is present in an amount of 0.1 to 10 wt. %, based on a total weight of the inkjet ink.
(6) The inkjet ink of any one of (1) to (5), wherein the (B2) cosolvent is at least one selected from the group consisting of n-propanol, methylethylketone, ethyl acetate, propylene glycol monomethyl ether, and 1,3-dioxolane.
(7) The inkjet ink of any one of (1) to (6), wherein a weight ratio of (B1) ethanol to (B2) cosolvent ((B1):(B2)) is 1:1 to 25:1.
(8) The inkjet ink of any one of (1) to (7), wherein the organoamine side chain is at least one selected from the group consisting of a monoamine comprising a primary amine and a diamine comprising a primary amine and a secondary amine.
(9) The inkjet ink of any one of (1) to (8), wherein the amine modified silicone (C) has a viscosity at 25° C. of 25 to 250 mm²/s.
(10) The inkjet ink of any one of (1) to (9), wherein the amine modified silicone has an amine functional group equivalent weight of 350 to 11,000 g/mol.
(11) The inkjet ink of any one of (1) to (10), wherein the amine modified silicone is present in an amount of 0.1 to 10 wt. %.
(12) The inkjet ink of claim 1, which is substantially free of a polyether-comprising surfactant.
(13) The inkjet ink of any one of (1) to (12), further comprising (D) an alkanolamine.
(14) The inkjet ink of (13), wherein the alkanolamine (D) is present in an amount of 0.01 to 5 wt. %, based on a total weight of the inkjet ink.
(15) The inkjet ink of (13), wherein the alkanolamine (D) is at least one selected from the group consisting of ethanolamine, propanolamine, isopropanolamine, diethanolamine, and triethanolamine.
(16) The inkjet ink of any one of (1) to (15), further comprising (E) a colorant.
(17) The inkjet ink of (16), wherein the colorant (E) is a metal complex azo dye.
(18) A printed article, comprising:
a substrate and a dried form of the inkjet ink of any one of (1) to (17) disposed on the substrate.
(19) A method of forming a printed image on a substrate, the method comprising:
applying the inkjet ink of any one of (1) to (17) onto the substrate with a thermal inkjet printhead; and
drying the inkjet ink,
wherein the substrate is substantially free of an amine-modified silicone.

### BRIEF DESCRIPTION OF THE DRAWINGS

The foregoing paragraphs have been provided by way of general introduction, and are not intended to limit the scope of the following claims. The described embodiments, together with further advantages, will be best understood by reference to the following detailed description when considered in conjunction with the accompanying drawings, wherein:

FIG. 1 illustrates the evaluation of printed inks for a “Good” rating (clearly readable, clear and well-defined image), an “Acceptable” rating (readable, mostly clear with some haziness or slight loss of edge definition), and a “Not Good” rating (not readable, lacks clarity and is poorly defined) for an alphanumeric sequence;

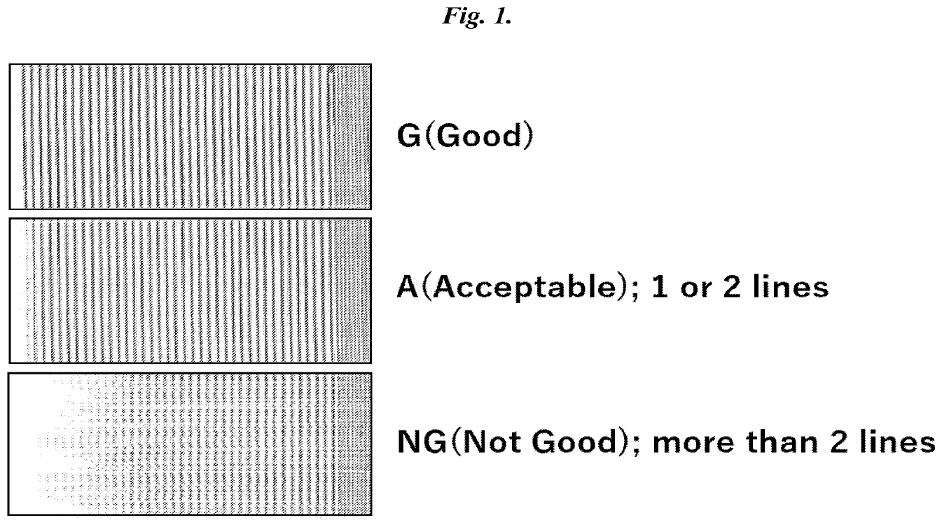

FIG. 2 illustrates the adhesion evaluation via the peeled tape test for a “Good” rating (little to no ink on tape; no change to print), an “Acceptable” rating (significant ink on tape; noticeable change to print, e.g. reticulation or fading), and a “Not Good” rating (large amount of ink on tape; print significantly degraded in quality, e.g. reticulation or fading) for a printed image.

### DETAILED DESCRIPTION OF THE INVENTION

In the following description, it is understood that other embodiments may be utilized and structural and operational changes may be made without departure from the scope of the present embodiments disclosed herein.

The phrase “substantially free”, unless otherwise specified, describes an amount of a particular component in the inkjet ink being less than 1 wt. %, preferably less than 0.5 wt. %, more preferably less than 0.1 wt. %, even more preferably less than 0.05 wt. %, yet even more preferably 0 wt. %, relative to a total weight of the inkjet ink.

As used herein, the terms “optional” or “optionally” means that the subsequently described event(s) can or cannot occur or the subsequently described component(s) may or may not be present (e.g., 0 wt. %).

The term “alkyl”, as used herein, unless otherwise specified, refers to a straight, branched, or cyclic, aliphatic fragment having at least 1, preferably at least 2, preferably at least 3, preferably at least 4 carbon atoms, and up to 22, preferably up to 20, preferably up to 18, preferably up to 12, preferably up to 8 carbon atoms. Examples of alkyl groups include, but are not limited to, methyl, ethyl, propyl, isopropyl, butyl, isobutyl, t-butyl, pentyl, isopentyl, neopentyl, hexyl, isohexyl, 3-methylpentyl, 2,2-dimethylbutyl, 2,3-dimethylbutyl, lauryl, myristyl, cetyl, stearyl, and the like, including guerbet-type alkyl groups (e.g., 2-methylpentyl, 2-ethylhexyl, 2-proylheptyl, 2-butyloctyl, 2-pentylnonyl, 2-hexyldecyl, 2-heptylundecyl, 2-octyldodecyl, 2-nonyltridecyl, 2-decyltetradecyl, and 2-undecylpentadecyl). Cycloalkyl is a type of cyclized alkyl group. Exemplary cycloalkyl groups include, but are not limited to, cyclopropyl, cyclobutyl, cyclopentyl, cyclohexyl, norbornyl, and adamantyl.

As used herein, the term “fatty” describes a compound with a long-chain (linear) hydrophobic portion made up of hydrogen and anywhere from 8 to 22 carbon atoms, which may be fully saturated or partially unsaturated.

As used herein, the term “aryl” refers to an aromatic group containing only carbon in the aromatic ring(s), such as phenyl, biphenyl, naphthyl, anthracenyl, and the like.

The term “arylalkyl”, as used herein, refers to a straight, branched, or cyclic alkyl moiety (as defined above) that is substituted by an aryl group (as defined above) which may itself be optionally substituted by an alkyl group, examples of which include, but are not limited to, benzyl, phenethyl, 3-phenylpropyl, 2-phenylpropyl, 1-phenylpropyl, 4-phenylbutyl, 3-phenylbutyl, 2-phenylbutyl, 2-methylbenzyl, 3-methylbenzyl, 4-methylbenzyl, 2,4-dimethylbenzyl, 2-(4-ethylphenyl)ethyl, 3-(3-propylphenyl) propyl, and the like.

As used herein, the term “fatty” describes a compound with a long-chain (linear) hydrophobic portion made up of hydrogen and anywhere from 8 to 22 carbon atoms, which may be fully saturated or partially unsaturated.

The term “(meth)acrylate” is used herein to refer to both acrylate and methacrylate groups. In other words, this term should be read as though “meth” is optional. Further, the term “(meth)acrylate” is used generally to refer to both acrylic acid-based compounds and acrylic ester-based compounds.

Throughout the specification, the term “boiling point” (b.p.) refers to the boiling point of a liquid measured at sea-level atmospheric pressure (i.e., 760 mmHg or 1 atmosphere), also called the normal boiling point, unless specified otherwise.

The term “decap behavior” herein, means the ability of the inkjet ink to readily eject from the printhead, upon prolonged exposure to air. The inkjet ink “decap time” is measured as the amount of time that an inkjet printhead may be left uncapped before the printer nozzles no longer fire properly, potentially because of clogging or plugging when printing resumes. Generally, nozzle(s) may become clogged (i.e., impeded, slowed) or plugged (i.e., obstructed, substantially or completely closed) by a viscous plug that forms in the nozzle(s) as a result of solvent loss, crusting of the ink, and/or kogation of various ink components in and/or around any of the nozzles. If a nozzle has become clogged, ink droplets ejected through the nozzle's orifice may be misdirected, which may adversely affect print quality. When an orifice is plugged, it becomes substantially or completely blocked. As a result of the nozzle being plugged, the ink droplets may not pass through the affected nozzle. Thus, the criteria for measuring failure to fire by a nozzle is a misdirection of ink through the nozzle's orifice to a lesser or greater degree, or a complete blockage, which can be measured by visually inspecting a printed image.

The term “reticulation” refers to a printing defect characterized by a withdrawal of ink film from portions of the substrate due to incompatibilities between the inkjet ink and the surface of the substrate. Reticulation often causes images to be produced with an “orange peel” or “pinhole” effect.

### Inkjet Inks

The present disclosure is directed to inkjet inks that possess suitable physical and chemical stability at both ambient temperatures and printhead operating temperatures, are jetted reliably, exhibit good adhesion to porous and non-porous substrates, and have prolonged decap times while still drying quickly after being applied onto a substrate.

Inkjet inks of the present disclosure generally include the following components: (A) a terpene phenol resin, (B) a solvent system comprising (B1) ethanol and (B2) a cosolvent, and (C) an amine modified silicone.

The inkjet inks of the present disclosure may also optionally include one or more of (D) an alkanolamine and (E) a colorant.

### (A) Resin(s)

In preferred embodiments, terpene phenol resin (A) employed in the inkjet ink is a copolymer comprising a monoterpene segment and a phenolic compound segment, wherein the terpene phenol resin (A) is a copolymer comprising a monoterpene segment and a phenolic segment comprising a phenolic compound, wherein the phenolic segment is connected to the monoterpene segment in at least one selected from the group consisting of an ortho-position relative to a phenolic hydroxyl group and a para-position relative to the phenolic hydroxyl group.

Terpene phenol resins (A) are copolymeric reaction products from alkylation of one or more phenolic compounds with one or more terpenes and have been used in inks and adhesives to provide a tackifier effect. As known by those of ordinary skill in the art, such resins may be readily obtained through copolymerization of phenol and terpene monomers under the catalytic action of strong acids, metal salts having a condensing effect, bleaching earths, Friedel-Craft catalysts (e.g., boron trifluoride), and the like. The copolymeric reaction products may also have other constitutional units other than constitutional units derived from phenolic compounds and constitutional units derived from terpene. That is, terpene phenol resin (A) contains both units derived from terpene unit and phenolic unit.

The amount of other constitutional unit other than terpen and phenol is preferably less than 5 wt. %, preferably less than 3 wt. %, preferably less than 1 wt. %, preferably substantially 0 wt. %, preferably 0 wt. % based on the total weight of constitutional units (100 wt. %) of the copolymeric reaction products.

The terpene phenol resins (A) utilized herein may be based on any terpene having at least one olefinic double bond that is capable of being alkylated by a phenolic compound. Terpenes have a basic skeleton (C₅H₈)ₚ where p is a positive integer that delineates the number of isoprene units that are successively bound head to tail. For example, hemiterpenes (p=1) have a C₅H₈ skeleton, monoterpenes (p=2) have a C₁₀H₁₆ skeleton, sesquiterpenes (p=3) have a C₁₅H₂₄ skeleton, and so forth.

In some embodiments, the terpene phenol resin (A) is based on monoterpene monomer units. The monoterpene may be a linear monoterpene (e.g., myrcene, ocimene, etc.), a monocyclic monoterpene (e.g., limonene, γ-terpinene, α-phellandrene, β-phellandrene, terpinolene, etc.), or a bicyclic monoterpene (e.g., 3-carene, α-pinene, β-pinene, α-fenchene, camphene, etc.), including the various stereoisomers thereof, as well as mixtures thereof. In preferred embodiments, the monoterpene is a bicyclic monoterpene, with particular preference to 3-carene, α-pinene, β-pinene, and camphene, more preferably α-pinene and/or β-pinene.

A phenolic compound has at least one hydroxyl group directly bonded to a phenyl ring. All mono- or polyvalent phenolic compounds are useful in the preparation of the terpene phenol resin (A) described herein provided that the phenolic compound has at least two replaceable hydrogen atoms in ortho- and/or para-positions with respect to at least one hydroxyl group. That is, the phenolic compound should be capable of being polyalkylated (e.g., bis-alkylated) with the terpene(s), and thus should have at least two available ortho-/para-positions with respect to at least one hydroxyl group for alkylation.

In preferred embodiments, the phenolic compound is phenol, which is considered the parent unsubstituted phenolic compound (i.e., contains one hydroxyl group bonded directly to the phenyl ring with no other substitution). Alternatively, the phenolic compound may be substituted at up to three positions in addition to the phenolic hydroxyl group, wherein one, two or three of the aromatic hydrogens of phenol are replaced with an equal number of substituents, each independently selected from a hydroxyl group; a C₁-C₂₂ alkyl group, preferably a C₂-C₁₈ alkyl group, more preferably a C₃-C₁₂ alkyl group, even more preferably a C₄-C₉ alkyl group, for example, methyl, ethyl, n-propyl, isopropyl, n-butyl, isobutyl, tert-butyl; a C₁-C₂₂ alkoxy group, preferably a C₂-C₁₂ alkoxy group, more preferably a C₃-C₆ alkoxy group, for example, methoxy, ethoxy, and isopropoxy; an aryl group; an arylalkyl group, for example a benzyl group; and a halo group such as chlorine, bromine, fluorine and iodine.

Specific examples of substituted phenolic compounds include, but are not limited to, o-cresol, m-cresol, p-cresol, 2,5-xylenol, 2,3-xylenol, 3,4-xylenol, 3,5-xylenol, 2,3,5-trimethylphenol, isopropylphenol (e.g., 4-isopropylphenol), tert-butylphenol (e.g., 4-tert-butylphenol), amylphenol (e.g., 4-tert-amylphenol), heptylphenol (e.g., 4-heptylphenol), octylphenol (e.g., o-octylphenol, p-octylphenol, etc.), nonylphenol (e.g., 4-(2,4-dimethylheptan-3-yl) phenol), decylphenol, dodecylphenol, diphenylolpropane (bisphenol-A), phenylphenol (e.g., 3-phenylphenol), cumylphenol, mequinol, benzyloxyphenol, guaiacol, ethoxyphenol (e.g., 4-ethoxyphenol), as well as polyhydric phenolic compounds such as resorcinol, pyrogallol, catechol, and p-hydroquinone, including mixtures of two or more of any of the above. Also included are fused ring phenols such as naphthols (e.g., 1-naphthol, 2-naphthol, etc.) and similar compounds.

In preferred embodiments, the terpene phenol resin (A) employed in the inkjet ink is a copolymer comprising a monoterpene segment wherein the monoterpene segment is at least one bicyclic monoterpene selected from the group consisting of 3-carene, α-pinene, β-pinene, and camphene; and the phenolic compound is phenol.

In more preferred embodiments, the terpene phenol resin (A) employed in the inkjet ink is a copolymer comprising a monoterpene segment wherein the monoterpene segment is at least one bicyclic monoterpene selected from the group consisting of α-pinene segment and phenol segment.

The terpene phenol resin (A) may be present in the inkjet inks in an amount of at least 0.1 wt. %, preferably at least 0.2 wt. %, more preferably at least 0.3 wt. %, even more preferably at least 0.4 wt. %, even more preferably at least 0.5 wt. %, and preferably up to 10 wt. %, more preferably up to 7.5 wt. %, even more preferably up to 5 wt. %, even more preferably up to 2.5 wt. %, even more preferably up to 2.0 wt. %, even more preferably up to 1.5 wt. %, even more preferably up to 1 wt. %, even more preferably up to 0.9%, based on a total weight of the inkjet ink.

The molecular weight of the terpene phenol resin (A) may vary depending on the monomers utilized, the reaction conditions, among many other factors, but typically terpene phenol resins (A) are used that have a weight average molecular weight of at least 200 g/mol, preferably at least 500 g/mol, more preferably at least 600 g/mol, even preferably at least 700 g/mol, and up to 3,000 g/mol, preferably up to 2,500 g/mol, more preferably up to 2,000 g/mol, even more preferably up to 1,500 g/mol.

The hydroxyl value (OHV) is defined as the number of milligrams of potassium hydroxide required to neutralize the acetic acid taken up on acetylation of one gram of a chemical substance that contains free hydroxyl groups. Therefore, the hydroxyl value, or the measure of the relative hydroxyl content of the terpene phenol resin (A), is directly correlated to the content of the phenolic compound(s) within the terpene phenol resin (A), with higher hydroxyl values indicating higher phenolic compound incorporation into the copolymer (and lower terpene incorporation). Hydroxyl values can be determined according to Japanese Industrial Standards JIS K 0070:1992 “Test methods for acid value, saponification value, ester value, iodine value, hydroxyl value, and unsaponifiable matter of chemical products.”

The hydroxyl value of the terpene phenol resin (A) employed in the disclosed inkjet inks may vary, however, typically those having hydroxyl values of preferably at least 10 mgKOH/g, preferably at least 12.5 mgKOH/g, preferably at least 15 mgKOH/g, preferably at least 17.5 mgKOH/g, preferably at least 20 mgKOH/g, and preferably up to 75 mgKOH/g, preferably up to 72.5 mgKOH/g, preferably up to 70 mgKOH/g, preferably up to 67.5 mgKOH/g, preferably up to 65 mgKOH/g, preferably up to 62.5 mgKOH/g, more preferably up to 60 mgKOH/g, even more preferably up to 55 mgKOH/g, even more preferably up to 50 mgKOH/g, even more preferably up to 45 mgKOH/g even more preferably up to 40 mgKOH/g, more preferably up to 35 mgKOH/g are preferred. Suitable examples of such terpene phenol resins (A) include, but are not limited to, U130 POLYSTER (OHV=25 mgKOH/g), U115 POLYSTER (OHV=30 mgKOH/g), T160 POLYSTER (OHV=60 mgKOH/g), T145 POLYSTER (OHV=65 mgKOH/g), available from Yasuhara Chemical Co. Ltd., and DERTOPHENE T (OHV=40 mgKOH/g), DERTOPHENE T160 (OHV=60 mgKOH/g) and DERTOPHENE T105 (OHV=30 mgKOH/g), available from Pinova.

In addition to the terpene phenol resin (A), the inkjet inks may optionally contain a terpene resin. The terpene resin may include small amounts of other constitutional units except phenol as constitutional units which can co-polymerize with terpene(s).

Such a terpene resin may be present in an amount of at least 0.1 wt. %, preferably at least 0.5 wt. %, preferably at least 1 wt. %, more preferably at least 1.5 wt. %, even more preferably at least 2 wt. %, yet even more preferably at least 2.5 wt. %, and up to 10 wt. %, preferably up to 9 wt. %, preferably up to 8 wt. %, preferably up to 7 wt. %, preferably up to 6 wt. %, more preferably up to 5 wt. %, even more preferably up to 4 wt. %, yet even more preferably up to 3 wt. %, based on a total weight of the inkjet ink.

Terpene resin refers to oligomers or polymers having at least 95 wt. %, preferably at least 96 wt. %, more preferably at least 97 wt. %, more preferably at least 98 wt. %, more preferably at least 99 wt. %, even more preferably at least 99.5 wt. %, yet even more preferably 100 wt. % of constitutional units derived from a polymerizable terpene(s), based on the total constitutional units (100 wt. %) of the terpene resin. Terpenes have a basic skeleton (C₅H₈) p where p is a positive integer that delineates the number of isoprene units that are successively bound head to tail. For example, hemiterpenes (p=1) have a C₅Hg skeleton, monoterpenes (p=2) have a C₁₀H₁₆ skeleton, sesquiterpenes (p=3) have a C₁₅H₂₄ skeleton, and so forth.

Exemplary terpene resins may be based on monoterpene monomer units. The monoterpene may be a linear monoterpene (e.g., myrcene, ocimene, etc.), a monocyclic monoterpene (e.g., limonene, γ-terpinene, α-phellandrene, β-phellandrene, terpinolene, etc.), or a bicyclic monoterpene (e.g., 3-carene, α-pinene, β-pinene, α-fenchene, camphene, etc.), including the various stereoisomers thereof, as well as mixtures thereof. The monoterpene may be a monocyclic monoterpene, such as to limonene. The monoterpene may be a bicyclic monoterpene, such as 3-carene, α-pinene, β-pinene, and camphene.

As known by those of ordinary skill in the art, such terpene resins may be readily obtained for example through catalytic polymerization/oligomerization (in solution) of α-pinene monomers, which are in turn typically derived from fractional distillation of gum and sulfate turpentines obtained from pines such as Pistacia terebinthus, Pinus pinaster, Pinus halepensis, Pinus massoniana, Pinus merkusii, Pinus palustris, Pinus taeda, and Pinus ponderosa.

The terpene resin may be a homopolymer made from α-pinene, with an α-pinene content (constitutional units derived from α-pinene) of at least 95 wt. %, preferably at least 96 wt. %, preferably at least 97 wt. %, preferably at least 98 wt. %, preferably at least 99 wt. %, more preferably at least 99.5 wt. %, even more preferably at least 99.9 wt. %, yet even more preferably 100 wt. %, based on the total constitutional units (100 wt. %) of the terpene resin. The terpene resin may be a homopolymer made from β-pinene, with a β-pinene content (constitutional units derived from β-pinene) of at least 95 wt. %, preferably at least 96 wt. %, preferably at least 97 wt. %, preferably at least 98 wt. %, preferably at least 99 wt. %, more preferably at least 99.5 wt. %, even more preferably at least 99.9 wt. %, yet even more preferably 100 wt. %, based on the total constitutional units (100 wt. %) of the terpene resin.

Typically, terpene resins used in inkjet inks have a number average molecular weight (Mn) of at least 330 g/mol, preferably at least 340 g/mol, preferably at least 400 g/mol, preferably at least 450 g/mol, preferably at least 500 g/mol, preferably at least 550 g/mol, preferably at least 600 g/mol, more preferably at least 650 g/mol, even more preferably at least 700 g/mol, yet even more preferably at least 750 g/mol, and up to 1,500 g/mol, preferably up to 1,300 g/mol, preferably up to 1,100 g/mol, preferably up to 1,000 g/mol, more preferably up to 900 g/mol, even more preferably up to 800 g/mol, yet even more preferably up to 790 g/mol.

The terpene resins may be in the form of a solid or a liquid at room temperature. When in the form of a solid, the terpene resin utilized may be categorized based upon its softening point (SP), for example according to a ring-and-ball softening point method. The ring-and-ball softening point is defined as the temperature at which a disk of the sample held within a horizontal ring is forced downward a distance of 1 in. (25.4 mm) under the weight of a steel ball as the sample is heated at a prescribed rate in a glycerol bath. For example, the ring-and-ball softening point may be determined according to JIS B7410-which is incorporated herein by reference in its entirety-Measuring apparatus: Automatic Ring-and-Ball Softening Point; Tester: ASP-MGK2, manufactured by MEITECH Company Ltd.; Heating rate: 5° C./min; Temperature at which heating is started: 40° C.; Measurement solvent: glycerol. Terpene resins having a variety of softening points may be used herein, for example those with a softening point of at least 20° C., preferably at least 22° C., preferably at least 24° C., preferably at least 26° C., preferably at least 28° C., preferably at least 30° C., preferably at least 40° C., preferably at least 50° C., preferably at least 60° C., preferably at least 80° C., preferably at least 100° C., preferably at least 110° C., preferably at least 115° C., more preferably at least 120° C., even more preferably at least 125° C., yet even more preferably at least 130° C., and up to 160° C., preferably up to 155° C., preferably up to 150° C., preferably up to 145° C., more preferably up to 140° C., even more preferably up to 138° C., yet even more preferably up to 135° C. In preferred embodiments, the terpene resin has a softening point of at least 20° C., preferably at least 22° C., more preferably at least 24° C., and up to 50° C., preferably up to 45° C., preferably up to 40° C., more preferably up to 35° C., even more preferably up to 30° C., yet even more preferably up to 28° C.

Bromine number is the amount of bromine (Br₂) in grams absorbed by 100 grams of a sample and is an indicator of the degree of unsaturation of the sample. In some embodiments, the terpene resin employed in the inkjet inks has a bromine number of at least 12, preferably at least 15, preferably at least 19, preferably at least 22, more preferably at least 25, even more preferably at least 26, yet even more preferably at least 27, and up to 35, preferably up to 34, preferably up to 33, more preferably up to 32, even more preferably up to 31, yet even more preferably up to 30, although terpene resins having a bromine number above or below (e.g., hydrogenated terpene resins) these values may also find use in the disclosed inkjet inks.

The inkjet inks of the present disclosure may be formulated with a single type of terpene resin, or with a combination of two or more types of terpene resins. Examples of terpene resins that may be employed in the inkjet inks herein, either alone or in combination, include, but are not limited to, PICCOLYTE A115 (ring-and-ball SP=112-118° C., bromine number=31.5), PICCOLYTE A125 (ring-and-ball SP=122-128° C., bromine number=31.5), PICCOLYTE A135 (ring-and-ball SP=132-138° C., bromine number=27), PICCOLYTE A135 PLUS (ring-and-ball SP=132-138° C.), PICCOLYTE AO PLUS (oligomer, liquid), PICCOLYTE A25 (ring-and-ball SP=22-28° C.), and PINOVA RESIN 2495 (ring-and-ball SP=132-138° C., bromine number=27), each being made from high purity α-pinene, available from Pinova, as well as PICCOLYTE S25 (made from high purity β-pinene, ring-and-ball SP=22-28° C., bromine number 19), available from Pinova.

In addition to the terpene phenol resin (A), the inkjet inks may optionally contain other binder resins/tackifiers/adhesive substances. Such other binder resins/tackifiers/adhesive substances may be present in an amount of at least 0.1 wt. %, preferably at least 0.5 wt. %, preferably at least 1 wt. %, more preferably at least 1.5 wt. %, even more preferably at least 2 wt. %, yet even more preferably at least 2.5 wt. %, and up to 10 wt. %, preferably up to 9 wt. %, preferably up to 8 wt. %, preferably up to 7 wt. %, preferably up to 6 wt. %, more preferably up to 5 wt. %, even more preferably up to 4 wt. %, yet even more preferably up to 3 wt. %, based on a total weight of the inkjet ink. Such additional resins, binders, tackifiers, or adhesive substances may include, but are not limited to,
rosin resins, such as rosin resins derived from gum rosin, wood rosin, and tall oil rosin (the main components of which are resin acids such as abietic acid, palustric acid, neoabietic acid, pimaric acid, isopimaric acid and/or dehydroabietic acid), including rosin resins formed by modifying the aforementioned rosins through esterification, hydrogenation (including partial hydrogenation), dimerization, and/or other modifications/functionalization (e.g., through Diels-Alder reaction with an unsaturated di-acid like maleic or fumaric acid/anhydride, carboxylic acid reduction to the respective aldehydes/alcohols, double bond isomerization, dehydrogenation, oxidation, disproportionation, and the like). Exemplary rosin resins include, but are not limited to (1) a rosin ester resin, such as e.g., an ester of a rosin composed mainly of an abietic type or pimaric type resin acid that has been reacted with an alcohol(s) such as glycerin, pentaerythritol, ethylene glycol, diethylene glycol, triethylene glycol, methanol, etc., and optionally hydrogenated or partially hydrogenated, with specific mention being made to HARIESTER products available from Harima Chemicals, Inc., STAYBELITE ESTER 10-E and PERMALYN 6110, each available from Eastman, SUPER ESTER A-125, SUPER ESTER A-75, PENSEL D-125, PINECRYSTAL KE-359 available from Arakawa Chemical Industries, Ltd., and FORAL 85, FORAL 105, HERCOLYN products, PEXALYN products, and PENTALYN products available from Pinova; (2) a hydrogenated acidic rosin such as FORAL AX and FORAL DX, each available from Pinova; (3) a partially hydrogenated acidic rosin such as STAYBELITE RESIN-E, available from Eastman, and STAYBELITE and STAYBELITE A, each available from PINOVA; (4) a dimerized rosin such as POLY-PALE partially dimerized rosin available from Eastman; and (5) a functionalized rosin resin, for example an ester (e.g., glycerol ester) of a rosin which has been modified with maleic anhydride or a rosin which has been subject to carboxylic acid reduction conditions, with specific mention being made to LEWISOL 28-M and Abitol-E hydroabietyl alcohol, each available from Eastman;
phenol resins (i.e. copolymers of phenolic compounds with formaldehyde), for example novolak resins such as PHENOLITE TD-2131 and PHENOLITE TD-2090 available from DIC Corp.;
polyamide resins, for example VERSAMID 725, 744, 756, 759 available from BASF Japan Ltd., TOHMIDE 90, 92, 394-N available from Sanho Chemical Co. Ltd., and SUNMIDE 550, 554, 615A, 638, 640 available from Evonik;
epoxy resins including sulfonamide-modified epoxy resins for example AD-PRO MTS available from Rit-Chem;
(meth)acrylate and styrene/(meth)acrylate resins for example JONCRYL 63, JONCRYL 67, JONCRYL 586, JONCRYL 611, JONCRYL 682, JONCRYL 693, available from BASF, PARALOID DM-55 and PARALOID B-66, available from Palmer Holland, PARALOID B-72, available from Dow Chemical, USA, and ELVACITE 2013, available from Lucite Inc.;
polyurethane resins, such as those formed from reaction between (i) polyols including, but not limited to, ethylene glycol, propylene glycol, propanediol, butanediol, polyethylene glycol, polypropylene glycol, polytetrahydrofuran diol, 3-methyl-1,5-pentanediol, 1,9-nonanediol, polyester polyols such as polyethylene glycol adipate diol, polyethylene glycol succinate diol, poly(3-methyl-1,5-pentanediol adipate) glycol, poly(3-methyl-1,5-pentanediol terephthalate) glycol, carbonate polyols, and (ii) diisocyanates including, but not limited to, 2,4-toluene diisocyanate, 2,6-toluene diisocyanate, 4,4-diphenylmethane diisocyanate, hexamethylene diisocyanate, and isophorone diisocyanate; for example PERMAX 200, PERMAX 202, and SANCURE 20025F, available from Lubrizol;
polyvinyl butyral resins, for example PIOLOFORM BN 16 and MOWITAL B20H available from Kuraray America, Inc.;
polyhydroxystyrene resins such as poly(p-hydroxy styrene) from DuPont;
vinyl resins, for example UCAR VYHH, VMCH, VMCA, and VAGF, available from Dow Chemical Company, and VINNOL E15/45, H14/36, E15/45M, and E16/40A, available from Wacker Chemie AG, Germany;
formaldehyde resins, including sulfonamide modified formaldehyde resins such as p-toluene sulfonamide formaldehyde resin, melamine formaldehyde resins, sulfonamide-modified melamine formaldehyde resins;
cellulose ester resins such as cellulose acetate butyrate (CAB-551-0.01) available from Eastman;
as well as polyesters, sulfonated polyesters, gums, cellulose ethers, cellulose nitrate resins, polymaleic anhydrides, acetal polymers, styrene/butadiene copolymers, ketone-aldehyde resins, and polyketone resins;
and the like, including mixtures thereof.

In some embodiments, the inkjet inks are substantially free of terpene resins. In some embodiments, other than the terpene phenol resin (A), and any optional terpene resin, the inkjet inks are substantially free of additional binder resins/tackifiers/adhesive substances, such as those mentioned above. In some embodiments, the terpene phenol resin (A) is the only resin present in the disclosed inkjet inks. In some embodiments, the inkjet inks are substantially free of rosin resins. In some embodiments, the inkjet inks are substantially free of rosin ester resins, partially hydrogenated acidic rosins, dimerized rosins, and other functionalized/modified rosin resins. In some embodiments, the inkjet inks are substantially free of phenol resins. In some embodiments, the inkjet inks are substantially free of polyamide resins. In preferred embodiments, the terpene phenol resin (A) is the only tackifier or adhesive resin present in the inkjet inks.

The terpene phenol resin (A) has been found to provide superior decap times and adhesion when used in combination with a solvent system (B) comprising ethanol (B1) and a cosolvent (B2) and an amine modified silicone. Without being bound by theory, it is believed that the terpene phenol resin (A) improves the decap behavior of the inkjet inks by forming a thin ‘skin’ or film covering within the printhead nozzles, thereby creating a temporary seal that prevents or reduces solvent losses during periods of inactivity, but where the ‘skin’ can be easily broken once the printing operation resumes. The polarity of the terpene phenol resin (A) is believed to be high enough for vehicle solubility, but not so high as to inhibit ‘skin’ formation from taking place due to too strong an interaction with the solvent system.

### (B) Solvent System

In many printing processes that utilize solvent-based inks, and particularly in thermal inkjet printing, the selection of an appropriate solvent system may impact the reliability of the printing process, the properties/appearance of the printed ink product, and the overall printing process efficiency. For example in thermal inkjet printing, the choice of solvent system May 1) aid bubble formation during the jetting process resulting in reliable ink jetting, 2) affect the stability/volatility of the inkjet inks by changing the interaction dynamics between the solvent(s) and the various inkjet ink components and thus the decap behavior, kogation, running stability, and/or drop trajectory, 3) impact the adhesion, rub and scratch resistance, and optical density properties of the printed image through the interactive forces between the solvent system and the other inkjet ink components even though the solvent(s) may no longer be present, or may be present in lesser amounts, after drying, 4) influence the drying time after application or the equipment needed to dry the applied ink, and/or 5) impact droplet dynamics.

In light of the above, particular preference is given herein to inkjet inks with a solvent system (B) that includes (B1) ethanol and (B2) a cosolvent. Examples of suitable cosolvents include, but are not limited to,
alcohols other than ethanol such as 1-propanol, 2-propanol, 1-butanol, 2-butanol, tert-amyl alcohol, 2-methyl-1-butanol, undecanols (e.g., 1-undecanol), dodecanols (e.g., 1-dodecanol), tridecanols (e.g., 1-tridecanol), tetradecanols (e.g., 1-tetradecanol), including terpene alcohols such as monoterpene alcohols (e.g., terpineol, geraniol, citronellol, linalool, etc.);
ketones such as acetone, methylethylketone, diethylketone, diphenylketone, dibenzylketone, acetophenone, cyclopentanone, methyl isopropyl ketone, methyl n-propyl ketone, ethyl isopropyl ketone (also known as 2-methyl-3-pentanone), 2-hexanone (also known as methyl butyl ketone), methyl isobutyl ketone, 3-hexanone, 3-pentanone, 2-pentanone, cyclohexanone, and diacetone alcohol;
ethers such as dimethyl ether, diethyl ether, dipropyl ether, methyl tert-butyl ether, tetrahydrofuran, 1,4-dioxane, dibutyl ether, and di-tert-butyl ether;
glycol ethers including monoalkyl glycol ethers, dialkyl glycol ethers, and monoalkyl monoester glycol ethers, such as ethylene glycol monomethyl ether (2-methoxyethanol), ethylene glycol monoethyl ether (2-ethoxyethanol), ethylene glycol mono-isopropyl ether (2-isopropoxyethanol), ethylene glycol mono-n-propyl ether (2-propoxyethanol), ethylene glycol mono-t-butyl ether, ethylene glycol monobutyl ether, ethylene glycol mono-isobutyl ether, ethylene glycol monophenyl ether (2-phenoxyethanol), ethylene glycol monobenzyl ether (2-benzyloxyethanol), diethylene glycol monomethyl ether (2-(2-methoxyethoxy) ethanol), diethylene glycol monoethyl ether (2-(2-ethoxyethoxy) ethanol), propylene glycol monomethyl ether (1-methoxy-2-propanol), propylene glycol monoethyl ether, propylene glycol mono-t-butyl ether, propylene glycol mono-n-propyl ether, propylene glycol mono-isopropyl ether, propylene glycol mono-n-butyl ether, dipropylene glycol monomethyl ether, propylene glycol methyl ether acetate, ethylene glycol dimethylether (dimethoxyethane), ethylene glycol diethyl ether (diethoxyethane), diethylene glycol dimethylether, diethylene glycol methyl ethyl ether, diethylene glycol diethylether, dipropylene glycol dimethyl ether, dipropylene glycol mono-n-propyl ether;
esters such as methyl acetate, ethyl acetate, n-butyl acetate, methyl lactate, ethyl lactate, butyl lactate, methoxyethyl acetate, ethoxyethyl acetate, methoxypropyl acetate, and ethoxypropyl acetate;
acetals such as 1,3-dioxolane;
amides such as dimethylformamide and dimethylacetamide;
acetonitrile
as well as mixtures of two or more thereof.

In some embodiments, the cosolvent (B2) has a solubility parameter which is preferably less than 16.5 (cal/cm³)^{1/2}, preferably less than 16 (cal/cm³)^{1/2}, preferably less than 15 (cal/cm³)^{1/2}, preferably less than 14 (cal/cm³)^{1/2}, preferably less than 13.5 (cal/cm³)^{1/2}, preferably less than 13.0 (cal/cm³)^{1/2}, preferably less than 12.5 (cal/cm³)^{1/2}, preferably less than 12 (cal/cm³) 1/2.

In some embodiments, the preferable cosolvent (B2) is at least one selected from the group consisting of n-propanol (solubility parameter 12.0 (cal/cm³)^{1/2}), methylethylketone (solubility parameter 9.0 (cal/cm³)^{1/2}), ethyl acetate (solubility parameter 9.1 (cal/cm³)^{1/2}), propylene glycol monomethyl ether (solubility parameter 11.2 (cal/cm³)^{1/2}), and 1,3-dioxolane (solubility parameter 8.6 (cal/cm³)^{1/2}).

In some embodiments, the solvent system is substantially free of 1-methoxy-2-propanol. In some embodiments, the solvent system is substantially free of butyl propionate.

The amount of ethanol (B1) preferable for attaining desirable ink properties (e.g. decap behavior, adhesion, etc.) may range from at least 50 wt. %, preferably at least 55 wt. %, preferably at least 60 wt. %, preferably at least 65 wt. %, preferably at least 70 wt. %, preferably at least 75 wt. %, preferably at least 80 wt. %, and up to 98 wt. %, preferably up to 97 wt. %, preferably up to 96 wt. %, more preferably up to 94 wt. %, even more preferably up to 92 wt. %, yet even more preferably up to 90 wt. %, yet even more preferably up to 88 wt. %, based on a total weight of the inkjet ink.

The cosolvent (B2) may be present in the inkjet inks in an amount of at least 0.5 wt. %, preferably at least 1 wt. %, preferably at least 2 wt. %, preferably at least 3 wt. %, preferably at least 4 wt. %, preferably at least 5 wt. %, more preferably at least 6 wt. %, more preferably at least 7 wt. %, more preferably at least 8 wt. %, and up to 45 wt. %, preferably up to 40 wt. %, preferably up to 35 wt. %, preferably up to 30 wt. %, preferably up to 25 wt. %, more preferably up to 20 wt. %, even more preferably up to 18 wt. %, even more preferably up to 16 wt. %, yet even more preferably up to 15 wt. %, based on a total weight of the inkjet ink.

In preferred embodiments, the ethanol (B1) together with the cosolvent (B2) constitute a majority of the solvent system (B) used in the inkjet inks, i.e., the combined weight of the ethanol (B1) and cosolvent (B2) may range from at least 50 wt. %, preferably at least 60 wt. %, more preferably at least 70 wt. %, preferably at least 80 wt. %, preferably at least 90 wt. %, preferably at least 95 wt. %, preferably at least 96 wt. %, based on a total weight of the solvent system (B).

Relative to ethanol (B1), preferred inkjet inks are those having a weight ratio of ethanol (B1) to the cosolvent (B2) ((B1):(B2)) of from 1:1, more preferably from 1.25:1, more preferably from 1.5:1, more preferably from 1.75:1, more preferably from 2:1, more preferably from 3:1, more preferably from 4:1 and preferably up to 25:1, more preferably up to 22.5:1, more preferably up to 20:1, more preferably up to 17.5:1, more preferably up to 15:1, more preferably up to 12.5:1, more preferably up to 11:1, more preferably up to 9:1.

Relative to terpene phenol resin (A), preferred inkjet inks are those having a weight ratio of ethanol (B1) to the terpene phenol resin (A) ((B1):(A)) ranging from at least 20:1, preferably at least 25:1, preferably at least 30:1, preferably at least 35:1, preferably at least 40:1, preferably at least 45:1, preferably at least 50:1, preferably at least 55:1, preferably at least 60:1, and up to 250:1, preferably up to 225:1, preferably up to 200:1, preferably up to 175:1, preferably up to 150:1, more preferably up to 125:1, more preferably up to 120:1, more preferably up to 115:1, more preferably up to 110:1, even more preferably up to 105:1, yet even more preferably up to 100:1, yet even more preferably up to 95:1, yet even more preferably up to 90:1.

While the amount of cosolvent (B2) can be adjusted, for example to provide the desired levels of solvation, preferred inkjet inks are those having a weight ratio of terpene phenol resin (A) to cosolvent (B2) ((A):(B2)) ranging from at least 1:75, preferably at least 1:70, preferably at least 1:65, preferably at least 1:60, preferably at least 1:55, preferably at least 1:50, preferably at least 1:45, preferably at least 1:42.5, more preferably at least 1:40, more preferably at least 1:37.5, more preferably at least 1:35, even more preferably at least 1:32.5, yet even more preferably at least 1:30, and up to 1:2, preferably up to 1:5, preferably up to 1:7, preferably up to 1:7.5, more preferably up to 1:8.

Other organic solvent(s) except the ethanol (B1) and the cosolvent (B2) may be used in any amount desired for a particular application, with typical loadings ranging up to 20 wt. %, preferably up to 15 wt. %, preferably up to 10 wt. %, preferably up to 5 wt. %, more preferably up to 4 wt. %, even more preferably up to 2 wt. %, yet even more preferably up to 1 wt. %, based on a total weight of the inkjet inks, though higher loadings may sometimes be used. In some embodiments, the inkjet inks are substantially free of methanol. In some embodiments, the inkjet inks are substantially free of polyols (also known as glycols) such as ethylene glycol, propylene glycol, 1,3-propanediol, 1,2-butanediol, 1,3-butanediol, 1,4-butanediol, 2,3-butanediol, 1,5-pentanediol, neopentyldiol, 1,6-hexanediol, and 2-methyl-2,4-pentanediol. In some embodiments, the inkjet inks are substantially free of other organic solvents.

In some embodiments, the inkjet inks are substantially free of solvents having a boiling point higher than 255° C., preferably solvents having a boiling point higher than 250° C., preferably solvents having a boiling point higher than 245° C., preferably solvents having a boiling point higher than 240° C., preferably solvents having a boiling point higher than 235° C., preferably solvents having a boiling point higher than 230° C., preferably solvents having a boiling point higher than 220° C., preferably solvents having a boiling point higher than 210° C., more preferably solvents having a boiling point higher than 200° C., even more preferably solvents having a boiling point higher than 195° C.

In preferred embodiments, the solvent system (B) consists of ethanol (B1), and a cosolvent (B2).

In preferred embodiments, the inkjet inks of the present disclosure are substantially non-aqueous, meaning that no water is added to the inkjet inks other than what may be incidental amounts of moisture derived from ambient conditions. In such cases, the inkjet inks may have less than 1 wt. %, preferably less than 0.5 wt. %, preferably less than 0.1 wt. %, more preferably less than 0.05 wt. %, even more preferably less than 0.01 wt. % of water, yet even more preferably 0 wt. %, based on the total weight of inkjet inks.

### Amine Modified Silicone (C)

The amine modified silicone may be a block copolymer having a pendent graft structure, which comprises or consists of (i) a silicone backbone (main chain) and (ii) one or more organoamine side chains attached to the silicone backbone, and optionally (iii) one or more fatty alkyl side chains attached to the silicone backbone. Therefore, as long as at least one organoamine side chain is attached to a silicone backbone, the material meets the definition of an “amino modified silicone” regardless of whether additional side chain types (e.g., fatty alkyl side chains) are also attached to the silicone backbone. Preferably, no other side chains, besides the organoamine side chain(s) and optionally the fatty alkyl side chain(s) are present in the amine modified silicone.

As referred to herein, “side chains” are not continuations of the silicone backbone—as would be the case in linear block copolymers, for example of A-B-A structure—but instead are attached to the silicone backbone (main chain) as pendent grafts thereby forming a branching point on the silicone backbone with the side chains extending from the silicone backbone via covalent bonds. Preferred organoamine modified silicones are those which are non-hydrolyzable, that is, where the side chains are attached to the silicone backbone via Si—C bonds.

< (i) silicone backbone> The silicone backbone may be based on any organosilicon polymer or oligomer (polyorganosiloxane) of linear or branched structure, of variable molecular weight, which can be formed from polymerization and/or polycondensation of suitably functionalized silanes, and which has a polysiloxane backbone structure (silicon atoms are linked together via oxygen atoms, —Si—O—Si—), with alkyl, aryl, and/or arylalkyl groups directly bonded to the (tetravalent) silicon atoms. For example, the polyorganosiloxane backbone may be a linear structure including, but not limited to, a polydimethylsiloxane (dimethicone) backbone (where each silicon atom in the backbone is directly bonded to two methyl groups), a poly(dimethylsiloxane-co-methylphenylsiloxane) backbone, a poly(dimethylsiloxane-co-diphenylsiloxane) backbone, and a poly(dimethylsiloxane-co-methylalkylsiloxane) backbone; or a branched structure with specific mention being made to a polydimethylsiloxyethyl dimethicone.

< (ii) organoamine side chain> The amine modified silicone contains at least one organoamine side chain, which is based on an organic amine or amine-containing polymer such as a polyaziridine, for example those formed from ring opening polymerization of one or more alkylene imines, with ethylene imine (aziridine), and propylene imine being the most preferred, including copolymers such as block copolymers thereof. Preferably, the organoamine side chain is an alkylamine, an arylamine, an arylalkylamine, a fatty amine, or a polyaziridine which extends from the silicone backbone.

The organoamine side chain may comprise a primary amine, a secondary amine, a tertiary amine, or a combination of these. Such amines may be present in any suitable number, for example from 1 to 1,000. In some embodiments, the preferable organoamine side chain is selected from the group consisting of a monoamine comprising a primary amine and a diamine comprising a primary amine and a secondary amine. Such a monoamine may be an alkylamine, an arylamine, an arylalkylamine, or a fatty amine. Such a diamine may be an alkylamine, an arylamine, an arylalkylamine, a or a fatty amine.

< (iii) fatty alkyl side chain> The amine modified silicone may optionally also be modified with one or more fatty alkyl side chains, such as those containing at least 8 carbon atoms, preferably at least 10 carbon atoms, more preferably at least 12 carbon atoms, and up to 22 carbon atoms, preferably up to 20 carbon atoms, more preferably up to 18 carbon atoms, even more preferably up to 16 carbon atoms, yet even more preferably up to 14 carbon atoms. Exemplary fatty alkyl side chain groups include, but are not limited to, capryl, nonyl, decyl, undecyl, lauryl, tridecyl, myristyl, pentadecyl, cetyl, palmitoleyl, heptadecyl, stearyl, oleyl, arachidyl, and behenyl, with specific mention being made to lauryl, myristyl, cetyl, and stearyl, preferably lauryl.

< (iv) polyether side chain> The amine modified silicone may optionally also be modified with one or more polyether side chains. The polyether side chain may be based on a polyalkylene glycol oligomer or polymer, for example those formed from ring opening polymerization of one or more alkylene oxides, with ethylene oxide (EO), propylene oxide (PO), and/or butylene oxide (BO) being the most preferred, including copolymers such as block copolymers thereof. Preferably, the polyether side chain is a polyethylene glycol or a polyethylene glycol-polypropylene glycol copolymer which extends from the silicone backbone, more preferably the polyether side chain is a polyethylene glycol side chain formed from only ethylene oxide, EO.

Various lengths of polyether side chain(s) may be utilized-typically, the number of moles of alkylene oxide units per side chain ranges from at least 2, preferably at least 3, more preferably at least 4, even more preferably at least 5, yet even more preferably at least 6, and up to 50, preferably up to 40, preferably up to 30, preferably up to 20, preferably up to 15, more preferably up to 12, even more preferably up to 10, yet even more preferably up to 9, with particular preference given to 3 to 10 moles, preferably 4 to 9 moles of ethylene oxide (EO) units per side chain.

Moreover, any polyether side chain present may be uncapped (whereby the end of the polyether side chain opposite of the silicone backbone terminates in —H, forming a terminal hydroxyl functional group) or may be capped with an alkyl group having 1, 2, 3, or 4 carbon atoms (forming a terminal alkyl ether group), with specific mention being made to methyl, ethyl, propyl, and butyl.

In some embodiments, the amine modified silicone is a block copolymer having a pendent graft structure, for example as represented by formula (I-A)

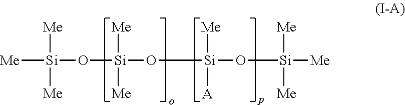

where:
o is 0 or a positive integer, for example at least 1, preferably at least 2, more preferably at least 3, even more preferably at least 4, yet even more preferably at least 5, and up to 500, preferably up to 400, preferably up to 300, more preferably up to 200, even more preferably up to 100, yet even more preferably up to 50;
p represents the number of constitutional units containing the organoamine side chain, and is a positive integer, for example at least 1, preferably at least 2, more preferably at least 3, even more preferably at least 4, yet even more preferably at least 5, and up to 100, preferably up to 80, preferably up to 60, more preferably up to 40, even more preferably up to 20, yet even more preferably up to 10; and
A is an amine containing group (organoamine) as described above.

The amine modified silicone having a pendent graft structure is formed from a linear polydimethylsiloxane backbone containing one or more organoamine side chains.

In some embodiments, the amine modified silicone is a block copolymer having a pendent graft structure and, optionally, one or more fatty alkyl side chains or polyether side chains as described above. In some embodiments, the amine modified silicone is a block copolymer having a pendent graft structure, wherein the pendant graft structure has a branched polydimethylsiloxane backbone containing one or more organoamine side chains and, optionally, one or more fatty alkyl side chains or polyether side chains as described above.

In some embodiments, the inkjet ink is substantially free of silicones devoid of an amine functionalization. Examples of such silicones include unmodified silicones (e.g., ones which do not have a side chain containing a non-siloxane functional group) and modified silicones having only other, non-amine functional groups, such as polyether modified silicones (e.g., ones having only a polyether side chain), mercapto modified silicones, vinyl modified silicones, silanol modified silicones, hydride modified silicones, epoxy modified silicones, (meth)acrylate modified silicones, carboxylate modified silicones, and haloalkyl modified silicones. In some embodiments, the inkjet ink is devoid of silicones devoid of an amine functionalization. That is, the inkjet ink does not contain a silicone which does not have an amine functionalization. In such embodiments, the amine modified silicone is the only silicone present in the inkjet ink. In some embodiments in which the inkjet ink is devoid of silicones devoid of an amine functionalization, the amine modified silicone may contain or comprise other functional groups, such as the ones listed above. In some embodiments in which the inkjet ink is devoid of silicones devoid of an amine functionalization, the amine modified silicone does not contain or comprise other functional groups. That is, the inkjet ink is devoid of silicones which do not have an amine functionalization and the amine modified silicone(s) present are devoid of non-amine functional groups.

In some embodiments, the amine modified silicone (C) preferably has a viscosity measured in mm²/s at 25° C. of at least 25, preferably at least 30, preferably at least 35, preferably at least 40, preferably at least 45, preferably at least 50, preferably at least 55, preferably at least 60 and up to 250, preferably up to 240, preferably up to 230, preferably up to 220, preferably up to 210, preferably up to 200, preferably up to 190, preferably up to 180, preferably up to 170, preferably up to 160, preferably up to 150, preferably up to 140, preferably up to 130, preferably up to 120, preferably up to 110 mm²/s.

In some embodiments, the amine modified silicone preferably has an amine functional group equivalent weight (FGEW) of 350 to 11,000 g/mol, preferably 1,000 to 9,000 g/mol, preferably 1,500 to 8,800 g/mol, preferably 1,700 to 7,600 g/mol, preferably 2,000 to 7,000 g/mol, preferably 3,000 to 6,500 g/mol, preferably 5,000 to 6,000 g/mol. The functional group equivalent weight refers to the weight of amine modified silicone that contains one formula-weight of the amine functional group.

Suitable examples of the amine modified silicone which may be employed in the disclosed inkjet inks include, but are not limited to, KF-865 (mono amino, functional group equivalent weight (FGEW)=5,000), KF-868 (mono amino, FGEW=8,800), KF-864 (mono amino, FGEW=3,800), KF-859 (diamino, FGEW=6,000), KF-393 (diamino, FGEW=350), KF-860 (diamino, FGEW=7,600), KF-880 (diamino, FGEW=1,800), KF-8004 (diamino, FGEW=1,500), KF-8002 (diamino, FGEW=1,700), KF-8005 (diamino, FGEW=11,000), KF-867 (diamino, FGEW=1,700), KF-8021 (diamino, FGEW=55,000), KF-869 (diamino, FGEW=3,800), and KF-861 (diamino, FGEW=2,000), each available from Shin-Etsu Chemical Co. Particularly preferred amine modified silicones are KF-859 and KF-865.

The amine modified silicone (C) may be present in the inkjet inks in an amount of at least 0.1 wt. %, preferably at least 0.125 wt. %, preferably at least 0.150 wt. %, preferably at least 0.175 wt. %, preferably at least 0.19 wt. %, preferably at least 0.20 wt. %, and up to 10 wt. %, preferably up to 7.5 wt. %, preferably up to 5 wt. %, preferably up to 2.5 wt. %, preferably up to 2.0 wt. %, preferably up to 1.5 wt. %, preferably up to 1.25 wt. %, preferably up to 1.2 wt. %, based on a total weight of the inkjet ink.

### Alkanolamine (D)

Alkanolamines are alkane-based compounds that contain both hydroxyl (—OH) and amino (primary, secondary, or tertiary) groups.

In some embodiments, the alkanolamine (D) has a total of at least 2 carbon atoms, preferably at least 3 carbon atoms, preferably at least 4 carbon atoms, and up to 8 carbon atoms, preferably up to 7 carbon atoms, more preferably up to 6 carbon atoms, more preferably up to carbon atoms.

In preferable embodiments, the alkanolamine (D) used in the inkjet inks herein has the following general formula II:

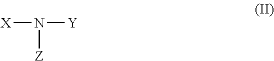

wherein X, Y and Z are independently selected from the group consisting of
hydrogen;
a C₁-C₅ alkyl group, preferably a C₂-C₃ alkyl group; and
an alkanol group, preferably a C₂-C₅ alkanol group, more preferably a C₃-C₄ alkanol group;
wherein at least one of X, Y and Z is an alkanol group (an alkyl substituent that bears at least one hydroxyl group).

In some embodiments, one of X, Y, and Z is an alkanol group. In some embodiments, two of X, Y, and Z are an alkanol group. In some embodiments, X, Y, and Z are all alkanol groups.

With respect to the one or more alkanol groups, the alkyl chain thereof may contain branching. Alternatively, the alkyl chain of the alkanol group may be linear (contains no alkyl branching). In preferred embodiments, the alkanol group(s) is based on a linear alkyl chain. Further, the hydroxyl bearing carbon of the alkanol group may be a primary, secondary, or tertiary carbon, preferably the hydroxyl bearing carbon is a primary or secondary carbon.

The alkanolamine (D) may contain a primary amino group (i.e., two of X, Y, and Z are hydrogen), a secondary amino group (i.e., one of X, Y, and Z are hydrogen), or a tertiary amino group (i.e., X, Y, and Z are all non-hydrogen). When an alkanolamine (D) is employed that contains a secondary amino group, the two non-hydrogen substituents may be the same or different alkanol groups, preferably the same alkanol group, for example as is the case in diethanolamine. When an alkanolamine (D) is employed that contains a tertiary amino group, the three non-hydrogen substituents may be the same or different alkanol groups, preferably the same alkanol group, for example as is the case in triethanolamine.

Suitable examples of the alkanolamine (D) include, but are not limited to, ethanolamine, N-methylethanolamine, N,N-dimethylethanolamine, N-ethylethanolamine, N-propylethanolamine, N-isopropylethanolamine, N,N-diisopropylethanolamine, N-butylethanolamine, diethanolamine, N-methyldiethanolamine, N-ethyldiethanolamine, triethanolamine, propanolamine (3-Amino-1-propanol), N-methylpropanolamine, N,N-dimethylpropanolamine, dipropanolamine, tripropanolamine, isopropanolamine, N,N-dimethylisopropanolamine, diisopropanolamine, triisopropanolamine, 2-amino-2-methyl-1-propanol, 2-amino-2-ethyl-1,3-propanediol, 4-amino-1-butanol, 2-amino-1-butanol, sec-butanolamine, and di-sec-butanolamine. In preferred embodiments, the alkanolamine (D) is at least one selected from the group consisting of ethanolamine, propanolamine (3-Amino-1-propanol), isopropanolamine, diethanolamine and triethanolamine.

In some embodiments, the alkanolamine (D) is present in the inkjet inks in amounts of at least 0.01 wt. %, more preferably 0.1 wt. % even more preferably 0.2 wt. % and preferably up to 5 wt. %, preferably up to 4 wt. %, preferably up to 3 wt. %, preferably up to 2.5 wt. %, preferably up to 2 wt. %, preferably up to 1.5 wt. %, preferably up to 1 wt. % relative to the total weight of the inkjet inks. In some embodiments, the weight ratio of the terpene phenol resin (A) to the alkanolamine (D) ((A):(D)) is at least 0.25:1, preferably at least 0.5:1, preferably at least 0.6:1, preferably at least 1:1, and up to 2.5:1, preferably up to 2:1, preferably up to 1.75:1, preferably up to 1.5:1, preferably up to 1.25:1.

### Colorant (E)

It is to be readily appreciated by those of ordinary skill in the art that one or more colorants (E) may be optionally included in the inkjet inks to provide colored inks. In other words, the inkjet of this invention may further comprise a colorant (E) and that may be used for a variety of printing purposes and the inkjet inks are not limited to any particular color. Any colorant (E) can be employed in the inkjet inks to provide the desired color, including dyes, pigments, mixtures thereof, and the like, provided that the colorant (E) can be dissolved or dispersed within the inkjet inks. Suitable colors include, for example, cyan, magenta, yellow, and key (black) (“CMYK”), white, orange, green, light cyan, light magenta, violet, and the like, including both spot colors and process colors.

The inkjet inks can be formulated with various dyes. The inkjet inks can be formulated with various inorganic pigments and/or organic pigments. In addition to providing color to the inkjet inks, such pigments may be capable of improving the light resistance, the weather resistance, etc., of the printed images.

Preferably, inkjet inks of the present disclosure comprise a colorant (E) comprising a metal complex azo dye. In this context, the term “metal complex azo dye” refers to a dye which comprises a compound formed from a metal center and a ligand which comprises an azo functional group (also known as a diazenyl functional group). Typically, the ligand which comprises an azo functional group is a molecule which itself may be considered an azo dye.

This ligand which comprises an azo functional group is coordinated to a metal center, typically a transition metal or main-group metal or metalloid but not an alkali metal or alkaline earth metal. Examples of suitable metals which may form the metal center include, but are not limited to titanium, vanadium, chromium, manganese, iron, cobalt, nickel, copper, zinc, zirconium, niobium, molybdenum, ruthenium, rhodium, cadmium, aluminum, indium, tin, bismuth, and mixtures thereof. Such coordination may be through any suitable functional group present on the ligand. Examples of such functional groups include, but are not limited to oxygen-containing functional groups such as alcohols, alkoxides, carboxylic acids and carboxylates, esters, ketones, and ethers; nitrogen-containing functional groups such as amine, amide, azide, diazenyl (azo groups), imine, porphyrin, imide, isonitrile, nitrile, and nitro functional groups; phosphorous-containing functional groups such as phosphine, phosphite, phosphate, phosphonite, phosphonate, phosphinite, and phosphinate functional groups; and sulfur-containing functional groups such as thiol, thiolate, disulfide, sulfone, sulfonic acid and sulfonate, sulfoxide, thial, thioester, thiosulfinate, thiocarboxylic acid and thiocarboxylate, sulfinic acid and sulfonate, thiocyanate, and isothiocyanate functional groups. The ligand coordinated to the metal center may be monodentate or bidentate, tridentate or tetradentate. Typically, ligands which comprise an azo group as used herein form a coordination interaction to the metal center through one or both of the nitrogen atoms which form the azo group.

In general, the rest of the inner coordination sphere of the metal center may be further filled by any suitable ligand or combination of ligands known to one of ordinary skill in the art. Examples of suitable ligands include species with oxygen-containing functional groups such as alcohols, alkoxides, hydroxides, carboxylic acids and carboxylates, esters, and ethers; species with nitrogen-containing functional groups such as amines (understood here to include ammonia), amides, azides, other diimides (also known as azo compounds), imines, porphyrins, imides, isonitriles, nitriles, and nitro compounds; species with phosphorous-containing functional groups such as phosphines, phosphites, phosphates, phosphonites, phosphonates, phosphinites, and phosphinates; species with sulfur-containing functional groups such as thiols, thiolates, disulfides, sulfones, sulfonic acids and sulfonates, sulfoxides, thials, thioesters, thiosulfinates, thiocarboxylic acids and thiocarboxylates, sulfinic acids and sulfinates, thiocyanates, and isothiocyanates; hydrocarbons containing one or more π-electron systems such as mesitylene, cyclopentadienyl anion, and cyclooctadecene; halides; and water. In general, the ligands, may be monodentate, bidentate, tridentate, tetradentate, or pentadentate as appropriate. Hexadentate ligands, however, such as ethylenediamine tetraacetic acid (EDTA) are not suitable as such ligands do not leave an open coordination site for coordination of a suitable ligand which comprises an azo functional group. In general, the functional groups may occupy any suitable location on a molecule which acts as a ligand. For example, alcohols or amines may be primary alcohols or amines, secondary alcohols or amines, or tertiary alcohols or amines as appropriate.

In preferred embodiments, the metal complex azo dye is a metal complex comprising a metal center and (E)-1-((2-methoxy-5-nitrophenyl)diazenyl) naphthalen-2-ol or a deprotonated form, demethylated form, deprotonated and demethylated form, tautomer, or stereoisomer thereof. The structure of (E)-1-((2-methoxy-5-nitrophenyl)diazenyl) naphthalen-2-ol is shown in Formula III, below:

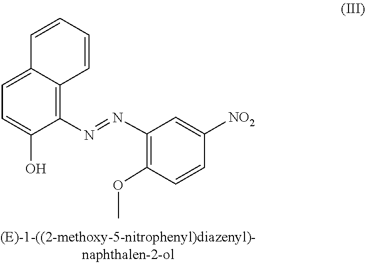 [SMILES: COc1ccc([N+](=O)[O-])cc1/N=N/c1c(O)ccc2ccccc12]

To form a suitable metal complex, the and (E)-1-((2-methoxy-5-nitrophenyl)diazenyl)naphthalen-2-ol may exist in a deprotonated form, in which the hydroxyl group is deprotonated to form an alkoxide type ligand (see Formula (IV-A) below), a demethylated form in which the methoxy group has been converted to an alkoxide type ligand (see Formula (IV-B) below), or a deprotonated and demethylated form in which the hydroxyl group is deprotonated to form an alkoxide type ligand and the methoxy group has been converted to an alkoxide type ligand (see Formula (IV-C) below).

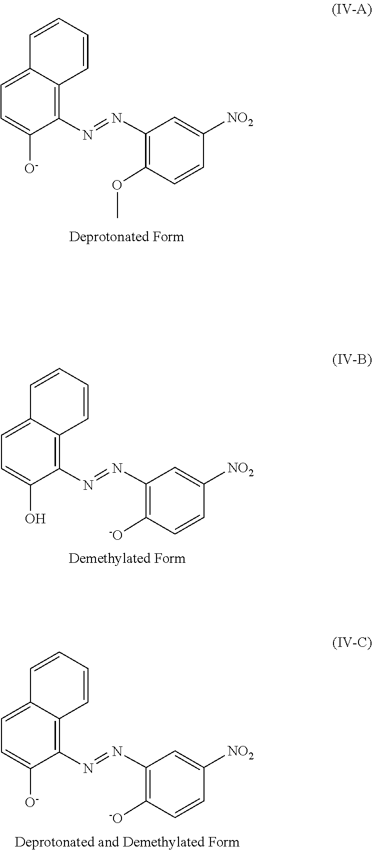

In preferred embodiments, the metal center is a chromium ion. In some embodiments, the chromium ion is in the +3 oxidation state. In such embodiments, the metal complex may have a positive charge, a negative charge, or have no charge. In embodiments in which the metal complex has a positive charge, the metal complex azo dye may further comprise any suitable anion for charge balance. Examples of such suitable anions include, but are not limited to carboxylates, halides, sulfates, phosphates, hydrogen phosphates, dihydrogen phosphates, nitrates, and mixtures thereof. In embodiments in which the metal complex has a negative charge, the metal complex azo dye may further comprise any suitable cation for charge balance. Examples of such suitable cations include, but are not limited to alkali metals, alkaline earth metals, ammonium compounds, and mixtures thereof.

Examples of suitable metal complex azo dyes include, but are not limited to Solvent Black 27, Solvent Black 28, Solvent Black 29, Solvent Black 34, Solvent Blue 137, Solvent Brown 37, Solvent Brown 42, Solvent Brown 43, Solvent Brown 52, Solvent Orange 54, Solvent Red 8, Solvent Red 109, Solvent Red 119, Solvent Red 122, Solvent Yellow 19, Solvent Yellow 21, Solvent Yellow 25, Solvent Yellow 82, Solvent Yellow 88, Solvent Yellow 146, Solvent Violet 58, Solvent Violet 61, as well as VALIFAST BLACK 3870, VALIFAST RED 1355, and VALIFAST YELLOW 3150 each available from Orient Chemical Industries Co., Ltd., with special mention being made to Solvent Black 29 (also sold under VALIFAST BLACK 3870 available from Orient Chemical Industries Co., Ltd) and Solvent Red 122 (also sold under VALIFAST RED 3312 available from Orient Chemical Industries Co., Ltd).

The colorant may be included in the inkjet ink to provide any desired color, including dyes, pigments, mixtures thereof, and the like, provided that the colorant can be dissolved or stably dispersed within the inkjet inks. Suitable colors include, for example, cyan, magenta, yellow, and key (black) (“CMYK”), white, orange, green, light cyan, light magenta, violet, and the like, including both spot colors and process colors.

In some embodiments, colorants (E) is present preferably in amount of at least 0.1 wt. %, more preferably at least 0.5 wt. %, more preferably at least 1 wt. %, more preferably at least 2 wt. %, more preferably at least 3 wt. %, and preferably up to 20 wt. %, more preferably up to 15 wt. %, more preferably up to 10 wt. %, more preferably up to 8 wt. %, more preferably up to 7 wt. %, relative to a total weight of the inkjet inks.

It is to be readily appreciated by those of ordinary skill in the art that one or more additional colorant(s) (E2) may be optionally included in the inkjet inks to provide colored inks that may be used for a variety of printing purposes and the inkjet inks are not limited to any particular color. Any additional colorant (E2) can be employed in the inkjet inks to provide the desired color, including dyes, pigments, mixtures thereof, and the like, provided that the additional colorant (E2) can be dissolved or dispersed within the inkjet inks. Suitable colors include, for example, cyan, magenta, yellow, and key (black) (“CMYK”), white, orange, green, light cyan, light magenta, violet, and the like, including both spot colors and process colors. In general, the additional colorants (E2) may be employed in amounts of at least 0.1 wt. %, preferably at least 0.5 wt. %, preferably at least 1 wt. %, preferably at least 2 wt. %, preferably at least 3 wt. %, and up to 20 wt. %, preferably up to 15 wt. %, preferably up to 10 wt. %, preferably up to 8 wt. %, preferably up to 7 wt. %, relative to a total weight of the inkjet inks.

The inkjet inks can be formulated with various inorganic pigments and/or organic pigments. In addition to providing color to the inkjet inks, such pigments may be capable of improving the light resistance, the weather resistance, etc., of the printed images.

### Surfactant (F)

The inkjet inks of the present disclosure may optionally include (F) a surfactant, for example, to provide anti-blocking, ink acceptance, levelling, anti-cratering, increased surface slip, and/or substrate wetting properties, among other benefits, without sacrificing inkjet ink decap and adhesion performance. When employed, the amount of surfactant (F) used may range from at least 0.01 wt. %, preferably at least 0.015 wt. %, preferably at least 0.02 wt. %, preferably at least 0.04 wt. %, more preferably at least 0.06 wt. %, even more preferably at least 0.08 wt. %, even more preferably at least 0.1 wt. %, even more preferably at least 0.15 wt. %, even more preferably at least 0.2 wt. %, even more preferably at least 0.25 wt. %, even more preferably at least 0.3 wt. %, even more preferably at least 0.35 wt. %, even more preferably at least 0.4 wt. %, even more preferably at least 0.45 wt. %, even more preferably at least 0.5 wt. %, and up to 5 wt. %, preferably up to 4 wt. %, preferably up to 3 wt. %, preferably up to 2 wt. %, preferably up to 1 wt. %, preferably up to 0.95 wt. %, preferably up to 0.9 wt. %, even more preferably up to 0.85 wt. %, even more preferably up to 0.8 wt. %, based on a total weight of the inkjet ink.

Examples of surfactants (F) which may be used herein, singly or in combination, include, but are not limited to,
polysiloxanes including organomodified silicones (e.g., alkyl, aryl, and/or arylalkyl modified silicones) such as SILTECH C-32, available from Siltech Corporation, COATOSIL 1211C and 3573, each available from Momentive, KF-410 (an arylalkyl-modified polydimethylsiloxane), available from Shin-Etsu Chemical Co., and BYK-322 and BYK-323 (arylalkyl-modified poly(dimethylsiloxane-co-methylalkylsiloxane)), each available from BYK Additives & Instruments;
silicone acrylate copolymers such as KP-541, KP-543, KP-545, KP-550, and KP-575 (acrylic polymers grafted with polydimethylsiloxane side chains, available from Shin-Etsu Chemical Co., Ltd.), and BYK-3550 (available from BYK Japan K.K.);
polyether modified silicones, including those which are block copolymers having a pendent graft structure formed from a linear or branched polydimethylsiloxane backbone containing one or more polyether side chains and optionally one or more fatty alkyl side chains as described above;
fluoropolymers such as FC-4430 and FC-4432, available from 3M Corporation;
polyether modified silicones, including those which are block copolymers having a pendent graft structure formed from a linear or branched polydimethylsiloxane backbone containing one or more polyether side chains and optionally one or more fatty alkyl side chains, such as KF-6013 (PEG-9 dimethicone, uncapped, HLB=10.0), KF-6015 (PEG-3 dimethicone, uncapped, HLB=4.5), KF-6017 (PEG-10 dimethicone, uncapped, HLB=4.5), and KF-6038 (Lauryl PEG-9 polydimethylsiloxyethyl dimethicone, uncapped, HLB=3.0), each available from Shin-Etsu Chemical Co., and BYK-307 (polyether modified polydimethylsiloxane), available from BYK Additives & Instruments as described above;
photo-cross-linkable silicone acrylates or silicone polyether acrylates such as TEGO RAD 2100, TEGO RAD 2200, TEGO RAD 2250, TEGO RAD 2300 (silicone polyether acrylate), each available from Evonik Industries, and BYK-UV 3500 and 3530, available from BYK;
polyacrylates including polyacrylate copolymers and cross-polymers such as BYK-381 and BYK-361N (polyacrylate copolymer), each available from BYK, PEMULEN EZ-4U (acrylate/C₁₀-C₃₀ alkyl acrylate crosspolymer) and PEMULEN TR-2 (acrylic acid/C₁₀-C₃₀ alkyl acrylate crosspolymer), each available from Lubrizol;
acetylenic diol and acetylenic glycol-based gemini surfactants such as SURFYNOL SEF and DYNOL surfactants, available from Evonik Industries;
polysiloxane-based gemini surfactants such as TEGO TWIN 4100, available from Evonik Industries;
non-ionic polyethers for example as substrate wetting surfactants such as TEGO WET 510 (hydrophilic polyether substrate wetting surfactant), available from Evonik Industries;
amides or monoalkanolamides of fatty acids, including alkoxylated monoalkanolamides of fatty acids such as coconut fatty acid monoethanolamide and coconut fatty acid monoethanolamide reacted with 2-20 moles of ethylene oxide;
ethers, such as alkoxylated C₁-C₂₂ alcohols including alkoxylated fatty alcohols such as BIO-SOFT N-600 (C₁₂-C₁₃ alcohol ethoxylate), MAKON DA-4 (ethoxylated isodecyl alcohol), MERPOL SE (alcohol ethoxylate), and POLYSTEP TD-6 (ethoxylated tridecyl alcohol), each available from Stepan, ethylene oxide/propylene oxide copolymers, alkoxylated alkylphenols, and alkyl polyglycosides (APGs) such as those made from reaction between fatty alcohols and glucose;
fatty esters such as ethoxylated and/or propoxylated fatty acids (e.g., castor oil with 2 to 40 moles of ethylene oxide), alkoxylated glycerides (e.g., PEG-24 glyceryl monostearate), glycol esters and derivatives, monoglycerides, polyglyceryl esters, esters of polyalcohols, and sorbitan/sorbitol esters like sorbitan monolaurate (e.g., EMASOL L-10V, available from Kao) and polysorbates including mono-, bi- or tri-fatty acid esterified polysorbates such as TOXIMUL SEE-340 (sorbitan trioleate ethoxylate (20)), available from Stepan;
glycosides of fatty alcohols such as PLANTASENS NATURAL EMULSIFIER HE20 (cetearyl glucoside, sorbitan olivate), available from Clariant;
sulfates, sulfonates, phosphates, and phosphonates, such as alkyl sulfates, alkyl-ester-sulfates, alkyl ether sulfates, alkyl-alkoxy-ester-sulfate, sulfated alkanolamides, glyceride sulfates, alkyl sulfonates, fatty alkyl-benzene sulfonates, lower alkyl-benzene sulfonates, alpha olefin sulfonates, lignosulfonates, alkyl aryl ether phosphates, alkyl ether phosphates, and phosphates of fatty alcohols or polyoxyalkylene ethers of fatty alcohols; and
amphoteric surfactants including, but not limited to: fatty alkyl betaines such as lauryl betaine (e.g., AMPHITOL 24B, available from Kao); fatty alkyl amido betaines such as fatty amidopropyl dimethylamino betaine; fatty alkyl sultaines such as fatty dimethyl hydroxysultaine; fatty alkyl amido sultaines such as fatty amido propyl dimethylamino hydroxysultaine; amine oxides, such as N-cocoamidopropyl dimethyl amine oxide, dimethyl fatty alkyl amine oxides such as dimethyl coco amine oxide, lauryldimethyl amine oxide (e.g., AMPHITOL 20N, available from Kao); and imidazole-based amphoteric surfactant
s (e.g., ELEC AC, available from Kao).

In some embodiments, the inkjet inks of the present disclosure are substantially free of silicone-comprising surfactants. In some embodiments, the inkjet inks of the present disclosure are substantially free of polyether-comprising surfactants. In some embodiments, the inkjet inks of the present disclosure are substantially free of surfactants, such as those listed above.

### (G) Additive(s)

In addition to the components already mentioned, the inkjet inks may also optionally be formulated with various additives (G) to improve various ink characteristics and performance. For example, the inkjet inks may optionally contain one or more of an anti-kogation agent, a stabilizer, a humectant, a security taggant, or other inkjet ink additive(s) known by those of ordinary skill in the art, in art appropriate levels.

The inkjet inks may optionally contain one or more opacifying agents, examples of which may include, but are not limited to, titanium dioxide, zirconium silicate, zirconium oxide, tin oxide, cerium oxide, zinc oxide, aluminum oxide, silica, kaolin, calcium carbonate, magnesium carbonate, calcium magnesium carbonate, barium carbonate, sodium feldspar, potassium feldspar, nepheline, calcium silicate, mullite, wollastonite, and talc.

### Methods of Making

Embodiments of the inkjet inks described herein may be prepared by any suitable technique known to those of ordinary skill in the art, for example by combining (A) a terpene phenol resin, solvent system (B) comprising (B1) ethanol and (B2) a cosolvent, (C) amine modified silicone and any desired optional ingredients (e.g., terpene resin, (E) a colorant, (D) an alkanolamine, (F) a surfactant, and/or (G) an additive in any order and stirring, agitating, and/or homogenizing at a temperature between 20 and 100° C. for a suitable amount of time to form a homogeneous solution.

The resulting inkjet ink may then be placed into a printing cartridge, such as e.g., a FUNAI TIJ cartridge made by Funai Co., or other printhead suitable for ketone-based ink.

### Properties

The inkjet inks disclosed herein possess extended decap times, for example as measured by printing a narrow line picture (e.g., barcode) (1 mm*1 cm, narrow lines, Monochrome bitmap), exposing the inkjet ink to air (decapping the ink cartridge) for a particular time (e.g., 30 seconds, 1 minute, 10 minutes, 60 minutes, etc.), reprinting the same narrow line image, and comparing the reprinted image after decapping to the original image to determine if loss of lines/loss of line clarity occurs in the narrow line image. If no loss of lines/loss of line clarity occurs at the tested time interval, then the inkjet inks are given a “Good” decap rating for that time interval. If 1-2 lines are lost/lost clarity at the tested time interval, but not enough to significantly affect the clarity or readability of the narrow line image, then the inkjet inks are given an “Acceptable” decap rating for that time interval. If more than 2 lines are lost/lost clarity at the tested time interval, then the inkjet ink is classified as “Not Good” at that time interval. Suitable inkjet inks are those which achieve an “Acceptable” or “Good” decap classification when decapped (i.e., exposed to air) for 30 seconds or longer, preferably 1 minute or longer, more preferably 10 minutes or longer, even more preferably 30 minutes or longer, yet even more preferably 60 minutes or longer.

The inkjet inks disclosed herein are also characterized by superior adhesion to a variety of substrates. Adhesion is typically tested using a “peeled tape test” in which an adhesive tape, typically 3M Scotch® tape, is applied to a dried printed ink, then removed. Good ink adhesion is characterized by little to no ink being removed from the substrate, i.e. little to no ink detectable on the adhesive tape, and/or no detectable change to the printed ink. An “Acceptable” rating is characterized by a significant amount of ink being removed from the substrate, i.e. ink visible on the adhesive tape, and/or a noticeable change to the printed ink, e.g. reticulation or fading. A “Not Good” rating is characterized by a large amount of ink being removed from the substrate, i.e. large amounts of ink visible on the adhesive tape (a reproduction of the print may be visible on the adhesive tape), and/or the print is significantly degraded in quality, e.g. reticulation or fading).

The inkjet inks disclosed herein may also be characterized by a long running stability (also known as ink longevity or print longevity). To test the inkjet inks for running stability, a narrow line image (e.g., barcode) (1 mm*1 cm, narrow lines, Monochrome bitmap) may be printed uninterrupted for a consecutive number of pages (e.g., printed on 3,000 pages in a continuous printing operation), and the print quality may be assessed throughout the printing operation by visually inspecting certain pages (e.g., 1,000^{th}, 2,000^{th}, and 3,000^{th} page) for missing nozzles. If no loss of lines/loss of line clarity occur in the page being inspected, then the inkjet ink is given a “G” (Good) running stability rating for that page. If 1-2 lines are lost/lost clarity in the page being inspected, but not enough to significantly affect the clarity or readability of the narrow line image, then the inkjet ink is given an “A” (Acceptable) running stability rating for that page. If more than 2 lines are lost/lost clarity in the page being inspected, then the inkjet ink is given an “NG” (Not Good) running stability rating for that print. Inkjet inks which maintain a “G” or “A” rating, preferably a “G” rating, when printed for at least 100 pages, preferably at least 500 pages, preferably at least 1,000 pages, preferably at least 1,500 pages, preferably at least 2,000 pages, preferably at least 2,500 pages, preferably at least 3,000 pages, preferably at least 3,500 pages, preferably at least 4,000 pages, preferably at least 4,500 pages, preferably at least 5,000 pages, are considered desirable in terms of running stability (ability to remain dispersed/suspended without settling/sedimentation and improper jetting).

### Printed Article

The inkjet inks can be printed on various substrates including three-dimensional parts as well as flat sheets or webs that are supplied in roll form, for the manufacture of a wide variety of printed articles. While flat substrates are suitable substrates for forming printed articles, a particular advantage of the present disclosure is that the disclosed inkjet inks enable printed images to be formed on complex three dimensional substrates, such as those which are radial, curved, serrated, corrugated, fluted, lipped, and/or those which have a structured surface (e.g., grained surface), all of which are notoriously difficult substrates owing to the long distance that the ink must travel to reach all parts of the complex surface. The printed articles may be suitable in the graphic arts, textiles, packaging (e.g., food packaging, pharmaceutical packaging, etc.), lottery, direct mail, business forms and publishing industries, examples of which include a tag or label, a lottery ticket, a publication, packaging (e.g., food packaging, pharmaceutical packaging, blister packaging, other various flexible packing, etc.), a folding carton, a rigid container (e.g., a plastic cup or tub, glass containers, metal cans, bottles such as PET bottles, jars, and tubes), envelopes, corrugate, a point-of-sale display, and the like. Particularly preferred printed articles are those having a dried form of the inkjet ink disposed on a complex three-dimensional part of the printed article, for example, where the printed image is located on a fluted or corrugated portion of a plastic container, or on the concave dome-shaped bottom of a metal can.

The inkjet inks may be printed on porous (or penetrable) substrates, examples of which include, but are not limited to, non-coated paper, wood, membranes, corrugate (corrugated cardboard/fiberboard), and fabrics (including, for example, but not limited to, woven fabric, non-woven fabric, and foil-laminated fabric).

The inkjet inks may also be printed on non-porous (or non-penetrable substrates), for example, various plastics, glass, metals (e.g., steel, aluminum, etc.), and/or non-penetration papers (e.g., coated papers such as varnish coated papers), including, but not limited to, molded plastic or metal parts as well a flat sheets or rolls of plastic or metallic films. Examples include those substrates containing polyesters such as polyethylene terephthalate (PET), biaxially oriented polystyrene (OPS), polyolefins such as polyethylene (PE), polypropylene (PP), oriented polypropylene (OPP), and biaxially oriented polypropylene (BOPP), polylactic acid (PLA), nylon and oriented nylon, polyvinyl chloride (PVC), cellulose triacetate (TAC), polycarbonate, acrylonitrile butadiene styrene (ABS), polyacetal, polyvinyl alcohol (PVA), coated papers such as varnish coated papers, and metals such as steel and aluminum, and the like.

### Method of Forming a Printed Image

With inkjet printing, a desired printed image is formed when a precise pattern of dots is ejected from a drop-generating device, known as a printhead, onto a print medium. The printhead has an array of precisely formed nozzles located on a nozzle plate and attached to an inkjet printhead substrate. The inkjet printhead substrate incorporates an array of firing chambers that receive inkjet ink through fluid communication with one or more ink reservoirs. Each firing chamber has a resistor element, known as a firing resistor, located opposite the nozzle so that the inkjet ink collects between the firing resistor and the nozzle. Each resistor element is typically a pad of a resistive material and measures for example about 35 μm×35 μm. The printhead is held and protected by an outer packaging referred to as a print cartridge or an inkjet pen. Upon energizing of a particular resistor element, a droplet of inkjet ink is expelled through the nozzle toward the print medium. The firing of ink droplets is typically under the control of a microprocessor, the signals of which are conveyed by electrical traces to the resistor elements, forming alphanumeric and other image patterns on the print medium. Since the nozzles are small, typically 10 μm to 40 μm in diameter, inks that minimize clogging are desired. In particular, since thermal inkjet (TIJ) is an open atmosphere print head design (the nozzle orifices are open to atmosphere and there is no valve seal at the orifice to allow ink pressurization), TIJ printing has historically suffered from poor performance during intermittent printing, where decap time (print idle time) causes premature drying of ink in and around the nozzles.

The present disclosure provides a method of forming a printed image on a substrate by applying the inkjet ink of this invention onto the substrate with a thermal inkjet printhead and drying the inkjet ink. Use of the inkjet inks described herein overcomes the problem of short decap time (rate of solvent loss is too fast) commonly associated with thermal inkjet processes.

In some embodiments, the substrate is substantially free of an amine-modified silicone. Such an amine-modified silicone can be present on a surface of the substrate. In some printing methods or applications, an amine-modified silicone is applied to a substrate prior to applying an ink. Preferably, the method described herein does not include application of an amine-modified silicone prior to applying the inkjet ink. Preferably, in the method described herein, the inkjet ink is applied to a surface devoid of an amine-modified silicone.

Any drop on demand printhead known to those of ordinary skill in the art of inkjet printing can be used as printing units in the present method, including continuous printheads, thermal printheads, electrostatic printheads, and acoustic printheads, preferably a thermal printhead (having a thermal transducer) is used. Typical parameters, such as, for example, printing resolution, printing speed, printhead pulse warming temperature, driving voltage and pulse length, can be adjusted according to the specifications of the printhead. Printheads which are generally suitable for usage in the methods herein have a droplet size in the range of 2 to 80 μL and a droplet frequency in the range of 10 to 100 kHz, and high quality prints may be obtained for example by setting the driving voltage to 8.0 to 9.5 Volts, the print speed up to 300 feet/minute, the pulse warming temperature to 25 to 45° C., and the pulse length to 0.7-2.5 microseconds, although values above or below these described may also be used and still obtain satisfactory prints. One non-limiting printhead example suitable for use in the disclosed methods is HP TIJ cartridge made by HP.

After application, the inkjet ink is dried. In some embodiments, external heat may be applied to dry the applied inkjet inks, for example, through the use of a heater. However, it is preferred that no external heat is applied to facilitate drying or to increase drying speeds. Therefore, in preferred embodiments, drying is achieved by allowing the applied inkjet ink to dry under ambient conditions (in air, at about 23° C.) for 30 seconds or less, preferably 25 seconds or less, more preferably 20 seconds or less, even more preferably 15 seconds or less, yet even more preferably 10 seconds or less, without the use of an external heat source such as a heater. Furthermore, the methods of the present disclosure do not require energy curing (e.g., UV or electron beam curing). Once the applied ink is deemed dry, further coatings of inkjet ink may be applied, or any processing steps known to those of ordinary skill in the art may be performed as desired.

It should also be recognized that substrate surface treatments such as corona treatment, atmospheric plasma treatment, and flame treatment may optionally be employed in the methods herein prior to application of the inkjet inks to improve printed article characteristics, for example ink adhesion. The parameters of such substrate surface treatments may be varied greatly depending on the substrate material to be printed, the specific inkjet ink utilized, the printing method applied, and the desired properties and applications of the printed article.

The examples below are intended to further illustrate the inkjet inks and are not intended to limit the scope of the claims.

### Examples

### Materials

DERTOPHENE T105 is a terpene phenol resin (OHV=20-60 mgKOH/g; SP=105° C.; Mw=about 700 g/mol), available from DRT/Pinova. Shin Etsu KF865 is a side-chain type mono amino-modified siloxane (Viscosity=110 mm²/s at 25° C.; Specific Gravity=0.97 at 25° C.; Refractive Index=1.405 at 25° C.; Functional Group Equivalent Weight=5,000 g/mol), Shin Etsu KF 859 is a side-chain type diamino-modified siloxane (Viscosity=60 mm²/s at 25° C.; Specific Gravity=0.96 at 25° C.; Refractive Index=1.403 at 25° C.; Functional Group Equivalent Weight=6,000 g/mol), and Shin Etsu KF6015 is a side-chain type polyether-modified siloxane (Viscosity=130 mm²/s at 25° C.; Specific Gravity=1.00 at 25° C.; Refractive Index=1.419 at 25° C.; Hydrophile Lipophile Balance (HLB)=4.5-5), each of which is available from Shin Etsu Silicone.

Valifast Black 3870 (also known as Solvent Black 29 or SB29) is a metal complex azo dye, available from Orient Chemical Industries. Valifast Red 3312 (also known as Solvent Red 122) is a metal complex azo dye, available from Orient Chemical Industries.

### Inkjet Ink Evaluation Methods

### Printing Sample Preparation

The inkjet ink examples were evaluated through a HP TIJ cartridge made by HP. Thermal printing technology related to HP was used to evaluate the inks (Software and hardware made by Norwix, Transport table made by Kirk Rudy).

### Decap Time Evaluation

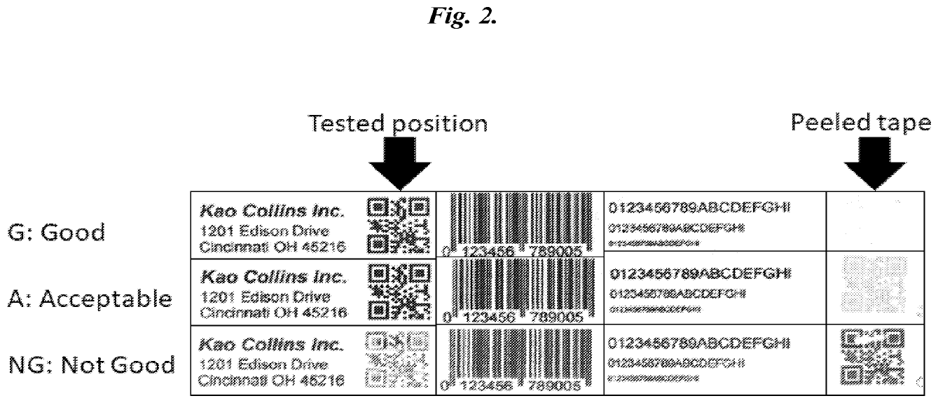

For evaluating decap times, the printing conditions utilized were as follows:
Printing substrate; normal (non-coated) paper
Printing resolution; 300 dpi*300 dpi (vertical*horizontal)
Voltage 8.6 V
Pulse width 1.8 μsec
Pulse warming OFF
Printing image; 100% duty (1 mm*1 cm, Monochrome bitmap, narrow line image) (see e.g., FIG. 2)

The narrow line image was printed to confirm that there were no missing or unclear lines included in the printed image (signifying plugged or missing nozzles). After confirming, the printhead was left decapped for a specific time (60 min), then reprinted using the same narrow line image. The reprinted narrow line image (after the specific time lapse) was checked to determine whether loss of lines/loss of line clarity occurred. If no loss of lines/loss of line clarity occurred, then the inkjet inks were given a “Good” decap rating for that time interval. If 1-2 lines were lost/lost clarity at the tested time interval, but not enough to significantly affect the clarity or readability of the narrow line image at the tested time interval, then the inkjet inks were given an “Acceptable” decap rating for that time interval. If more than 2 lines were lost/lost clarity at the tested time interval, then the inkjet inks were classified as “Not Good” at that time interval. Suitable/desirable inkjet inks are those which achieve a, “Acceptable” or “Good” decap classification when decapped (i.e., exposed to air) for each of the tested time intervals.

### Adhesion Evaluation

The ink was printed on LDPE films. 1 minute after printing, Scotch® Light Duty Packaging Tape 600 was applied to the ink with light pressure, then immediately peeled off. The performance of the ink was ranked according to the description provided in Table 1, below.

TABLE 1
Ink evaluation metrics

| | | Image quality | Adhesion |
|---|---|---|---|
| Rating | Description | outcome | (Tape Test) |
| Good | Clear images; | Clearly | Little to no ink on |
| | well-defined edges | readable | tape; no change to |
| | | | print |
| Acceptable | Images were mostly | Readable | Significant ink on |
| | clear but with some | | tape; noticeable |
| | haziness; slight | | change to print |
| | loss of edge | | |
| | definition | | |
| Not Good | Images lacked | Not readable | Large amount of ink |
| | clarity; poor edge | | on tape; print |
| | definition | | significantly |
| | | | degraded in quality |

### Inkjet Ink Examples

Example inkjet inks are given in Tables 2A-2B. The amount of each component is expressed in terms of weight percentage relative to a total weight (50 parts) of the inkjet ink. * denotes the example is a comparative example.

### Preparation Methods

To prepare the example inks, the resin(s), amino modified silicone, and any surfactant were first combined with the stated combination of ethanol, and cosolvent, and mixed by mechanical stirrer for at least 30 minutes. The dye was then added into the mixture and mixed for at least 30 minutes to obtain the inkjet inks. The inkjet ink examples were then evaluated through a HP TIJ cartridge made by HP.

TABLE 2A
Inkjet Ink Examples 1-8

| Component | | Ex 1 | Ex 2 | Ex 3 | Ex 4 | Ex 5 | Ex 6 | Ex 7 | Ex 8 |
|---|---|---|---|---|---|---|---|---|---|
| DERTOPHENE T105 | A | 0.50 | 0.50 | 0.50 | 0.50 | 0.50 | 0.50 | 0.50 | 0.50 |
| Ethanol | B1 | 41.25 | 40.80 | 40.65 | 40.65 | 40.95 | 40.95 | 40.95 | 40.95 |
| n-Propanol | B2 | 4.50 | 4.80 | 4.80 | 4.50 | 4.50 | 4.50 | — | — |
| Methylethyl Ketone | B2 | — | — | — | — | — | — | 4.50 | — |
| Ethyl Acetate | B2 | — | — | — | — | — | — | — | 4.50 |
| Propylene Glycol Monomethyl Ether | B2 | — | — | — | — | — | — | — | — |
| 1,3-Dioxolane | B2 | — | — | — | — | — | — | | — |
| Shin Etsu KF-859 | C | — | 0.15 | 0.30 | 0.60 | — | — | 0.30 | 0.30 |
| Shin Etsu KF-865 | C | — | — | — | — | 0.30 | — | — | — |
| Shin Etsu KF-6015 | C | — | — | — | — | — | 0.30 | — | — |
| Isopropanolamine | D | 0.50 | 0.50 | 0.50 | 0.50 | 0.50 | 0.50 | 0.50 | 0.50 |
| VALIFAST BLACK 3870 | E | 3.25 | 3.25 | 3.25 | 3.25 | 3.25 | 3.25 | 3.25 | 3.25 |
| VALIFAST RED 3312 | E | — | — | — | — | — | — | — | — |
| Total | | 50.0 | 50.0 | 50.0 | 50.0 | 50.0 | 50.0 | 50.0 | 50.0 |

TABLE 2B
Inkjet Ink Examples 9-16

| Component | | Ex 9 | Ex 10 | Ex 11 | Ex 12 | Ex 13 | Ex 14 | Ex 15 | Ex 16 |
|---|---|---|---|---|---|---|---|---|---|
| DERTOPHENE T105 | A | 0.50 | 0.50 | 0.50 | 0.50 | 0.50 | 0.50 | 0 | 0.50 |
| Ethanol | B1 | 40.95 | 40.95 | — | 45.45 | 30.45 | 20.45 | 41.95 | 42.35 |
| n-Propanol | B2 | — | — | 45.45 | — | 15.00 | 25.00 | 4.50 | 4.50 |
| Methylethyl Ketone | B2 | — | — | — | — | — | — | — | — |
| Ethyl Acetate | B2 | — | — | — | — | — | — | — | — |
| Propylene Glycol Monomethyl Ether | B2 | 4.50 | — | — | — | — | — | — | — |
| 1,3-Dioxolane | B2 | — | 4.50 | — | — | — | — | — | |
| Shin Etsu KF-859 | C | 0.30 | 0.30 | 0.30 | 0.30 | 0.30 | 0.30 | 0.30 | 0.30 |
| Shin Etsu KF-865 | C | — | — | — | — | — | — | — | — |
| Shin Etsu KF-6015 | C | — | — | — | — | — | — | — | — |
| Isopropanolamine | D | 0.50 | 0.50 | 0.50 | 0.50 | 0.50 | 0.50 | 0.50 | 0.50 |
| VALIFAST BLACK 3870 | E | 3.25 | 3.25 | 3.25 | 3.25 | 3.25 | 3.25 | 3.25 | — |
| VALIFAST RED 3312 | E | — | — | — | — | — | — | — | 1.85 |
| Total | | 50.0 | 50.0 | 50.0 | 50.0 | 50.0 | 50.0 | 50.0 | 50.0 |

### Inkjet Ink Performance

From Table 3 it can be seen that the combination of amine modified silicone, ethanol, a cosolvent, and a terpene phenol resin provided remarkable effects in terms of decap times and adhesion (Examples 3, 4, 5, 7, 8, 9, 10, and 13). Conversely, inkjet inks formulated without the amino modified silicone (Example 1), without cosolvent (Example 12) underperformed in each test, providing results categorized as “Not Good” for decap times and adhesion. The inclusion of a polyether modified silicone (Example 6) showed suitable decap times, but unacceptable adhesion. The exclusion of ethanol (Example 11) or terpene phenol resin (Example 15) showed good adhesion but unacceptable decap time behavior.

In terms of the quantity of cosolvent, loadings in the range of 4.5 to 15 parts (9 to 30 wt. %) were found to provide acceptable or good decap behavior and acceptable or good adhesion on all substrates (see Examples 2, 3, 4, 5, 7, 8, 9, 10, 11, 13, 14, and 16).

TABLE 3A
Evaluation of Inkjet Ink Examples 1-8

| | Ex 1 | Ex 2 | Ex 3 | Ex 4 | Ex 5 | Ex 6 | Ex 7 | Ex 8 |
|---|---|---|---|---|---|---|---|---|
| Adhesion | X | A | G | G | G | X | G | G |
| Decap | X | G | G | G | G | G | G | G |

TABLE 3B
Evaluation of Inkjet Ink Examples 9-16

| | Ex 9 | Ex 10 | Ex 11 | Ex 12 | Ex 13 | Ex 14 | Ex 15 | Ex 16 |
|---|---|---|---|---|---|---|---|---|
| Adhesion | G | G | G | X | G | G | G | A |
| Decap | G | G | A | X | G | A | X | A |

### G: Good; A: Acceptable; X: Not Good.

Where a numerical limit or range is stated herein, the endpoints are included. Also, all values and subranges within a numerical limit or range are specifically included as if explicitly written out.

As used herein the words “a” and “an” and the like carry the meaning of “one or more.”

The present disclosure also contemplates other embodiments “comprising”, “consisting of” and “consisting essentially of”, the embodiments or elements presented herein, whether explicitly set forth or not.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. An inkjet ink, comprising:
(A) a terpene phenol resin;
(B) a solvent system comprising (B1) ethanol and (B2) a cosolvent; and
(C) an amine modified silicone,
wherein the amine modified silicone (C) comprises a silicone backbone (main chain) and one or more organoamine side chains attached to the silicone backbone, and
wherein a ratio of (A) terpene phenol resin to (C) amine modified silicone is from 0.83 to 3.33.

2. The inkjet ink of claim 1, wherein the terpene phenol resin (A) is a copolymer comprising a monoterpene segment and a phenolic segment comprising a phenolic compound, wherein the phenolic segment is connected to the monoterpene segment in at least one selected from the group consisting of an ortho-position relative to a phenolic hydroxyl group and a para-position relative to the phenolic hydroxyl group.

3. The inkjet ink of claim 2, wherein:
the monoterpene segment is at least one bicyclic monoterpene selected from the group consisting of 3-carene, α-pinene, β-pinene, and camphene; and
the phenolic compound is phenol.

4. The inkjet ink of claim 1, wherein the terpene phenol resin (A) has a hydroxyl value of 10 to 75 mgKOH/g.

5. The inkjet ink of claim 1, wherein the terpene phenol resin (A) is present in an amount of 0.1 to 10 wt. %, based on a total weight of the inkjet ink.

6. The inkjet ink of claim 1, wherein the (B2) cosolvent is at least one selected from the group consisting of n-propanol, methylethylketone, ethyl acetate, propylene glycol monomethyl ether, and 1,3-dioxolane.

7. The inkjet ink of claim 1, wherein a weight ratio of (B1) ethanol to (B2) cosolvent ((B1):(B2)) is 1:1 to 25:1.

8. The inkjet ink of claim 1, wherein the organoamine side chain is at least one selected from the group consisting of a monoamine comprising a primary amine and a diamine comprising a primary amine and a secondary amine.

9. The inkjet ink of claim 1, wherein the amine modified silicone (C) has a viscosity at 25° C. of 25 to 250 mm²/s.

10. The inkjet ink of claim 1, wherein the amine modified silicone has an amine functional group equivalent weight of 350 to 11,000 g/mol.

11. (canceled)

12. The inkjet ink of claim 1, which is substantially free of a polyether-functionalized siloxane.

13. The inkjet ink of claim 1, further comprising (D) an alkanolamine.

14. The inkjet ink of claim 13, wherein the alkanolamine (D) is present in an amount of 0.01 to 5 wt. %, based on a total weight of the inkjet ink.

15. The inkjet ink of claim 13, wherein the alkanolamine (D) is at least one selected from the group consisting of ethanolamine, propanolamine, isopropanolamine, diethanolamine, and triethanolamine.

16. The inkjet ink of claim 1, further comprising (E) a colorant.

17. The inkjet ink of claim 16, wherein the colorant (E) is a metal complex azo dye.

18. A printed article, comprising:
a substrate and a dried form of the inkjet ink of claim 1 disposed on the substrate.

19. A method of forming a printed image on a substrate, the method comprising:
applying the inkjet ink of claim 1 onto the substrate with a thermal inkjet printhead; and
drying the inkjet ink,
wherein the substrate is substantially free of an amine-modified silicone.

20. A method of producing an inkjet ink, the method comprising
combining (A) a terpene phenol resin, solvent system (B) comprising (B1) ethanol and (B2) a cosolvent, and (C) an amine modified silicone, and then stirring, agitating, or homogenizing.

21. The method of claim 20, further comprising,
after the stirring, agitating, or homogenizing, adding (E) a colorant; and
mixing.
